(19) United States
(12) Patent Application Publication
(10) Pub. No.: US 2026/0310858 A1
(43) Pub. Date: Oct. 8, 2026

(54) SYSTEM AND METHODS FOR SIMULATING THE PHYSICAL BEHAVIOR OF OBJECTS

(71) Applicant: Ohio State Innovation Foundation, Columbus, OH (US)

(72) Inventor: Soheil SOGHRATI, Dublin, OH (US)

(21) Appl. No.: 19/474,838

(22) PCT Filed: Apr. 11, 2024
(86) PCT No.: PCT/US2024/024050

§ 371 Date: Oct. 13, 2025

Related U.S. Application Data
(60) Provisional application No. 63/495,602, filed on Apr. 12, 2023.

(51) Int. Cl. G06F 30/27; G06F 30/23

(52) U.S. Cl. CPC G06F 30/27; G06F 30/23

(57) ABSTRACT

Embodiments of the present disclosure provide an artificial intelligence (AI)-driven system and methods for modeling the response/behavior of physical objects within a digital environment. In some implementations, digital models of physical objects are processed using a domain decomposition method (DDM) model configured to solve a boundary value problem by splitting the digital model into a plurality of subdomains. Each subdomain can then be individually solved (e.g., using a deep learning model) to predict horizontal and vertical displacements or the whole displacement field, which in turn can be used to predict boundary conditions for the respective subdomain. From the respective boundary conditions, a displacement field over the entire domain and/or a stress field can be predicted.

### CROSS-REFERENCE TO RELATED APPLICATIONS

This application claims priority to and the benefit of U.S. Provisional Application No. 63/495,602, titled “SYSTEM AND METHODS FOR SIMULATING THE PHYSICAL BEHAVIOR OF OBJECTS,” filed on Apr. 12, 2023, the content of which is hereby incorporated by reference herein in its entirety.

### STATEMENT REGARDING FEDERALLY SPONSORED RESEARCH OR DEVELOPMENT

This invention was made with government support under grant/contract no. FA9550-21-1-0245 awarded by the Air Force Office of Scientific Research. The government has certain rights in the invention.

### BACKGROUND

One of the most commonly used numerical techniques for modeling and designing solid parts with different geometries and under various loads and boundary conditions is the finite element method (FEM). While FEM can handle a variety of physics (e.g., plasticity and damage), performing stress analysis using a simple linear elastic constitutive model is the most common type of simulation for the design of solid parts in industries such as automotive, aerospace, etc. However, there are several challenges associated with the implementation of FEM for modeling real-world problems. For example, the labor cost associated with the preparation of finite element (FE) models (e.g., including CAD drawing and mesh generation) is significant: on average, 80% of the modeling time, including the post-processing phase.

Mesh generation is also a challenging and computationally demanding task for problems with complex geometries. On the other hand, the computational cost of solving a 2D problem discretized using a mesh with N nodes can be defined as O(N²) to O(N³), which could be very high for massive problems and can require using a supercomputer to perform parallel simulations. In many cases, the exceedingly large number of elements needed in the Finite Element (FE) mesh (e.g., for modeling a composite aircraft wing) prohibits direct numerical simulation (DNS) due to limited computational resources and convergence issues; alternative and less accurate techniques such as multiscale methods or numerical homogenization are often deployed.

### SUMMARY

Embodiments of the present disclosure provide an artificial intelligence (AI)-driven system and methods for modeling the response/behavior of physical objects within a digital environment. At a high level, digital models of physical objects are processed using a domain decomposition method (DDM) model configured to solve a boundary value problem by splitting the digital model into a plurality of subdomains (e.g., smaller boundary value problems on subdomains). Each subdomain can then be individually solved (e.g., as a partial differential equation) using a deep learning model to predict horizontal and vertical displacements or the whole displacement field, which in turn can be used to update boundary conditions for the neighboring subdomains. From the respective boundary conditions, a displacement field and/or a stress field can be predicted. The outputs of the proposed system and methods can be employed to generate data (e.g., output data, user interface data, digital structures) for various applications, including simulations, computer-aided design (CAD) systems, and virtual reality (VR) systems, for example, to model and solve engineering design problems.

In some implementations, a system for simulating a physical behavior of objects is provided. The system can include: a processor; and memory having instructions stored thereon that, when executed by the processor, cause the system to: obtain a digital model of a physical object; decompose the digital model into a plurality of subdomains, wherein the plurality of subdomains at least partially overlap (often 50% overlap is used to facilitate the construction of subdomains), independently solve each subdomain of the plurality of subdomains using a deep learning model, wherein the deep learning model is trained to predict horizontal and vertical displacements (or the whole displacement field) for each subdomain of the plurality of subdomains; iteratively update displacement boundary conditions for each of the plurality of subdomains based on the respective predicted horizontal and vertical displacements (or the whole displacement field); and once convergence is achieved, predict at least one of a displacement field or a stress field using the updated boundary conditions for each subdomain of the plurality of subdomains.

In some implementations, the instructions further cause the system to: train the deep learning model to predict a response of each of the plurality of subdomains using a training data set, wherein the training data set includes at least one of subdomain geometry, material properties, horizontal and vertical displacements or the whole displacement field, and boundary conditions for a plurality of different types of subdomains.

In some implementations, the training data set is generated using finite element domain decomposition method (FE-DDM) simulations or by extracting multiple subdomains from finite element simulation of the field in a larger domain to solve each of the plurality of different types of subdomains.

In some implementations, the training data set is generated using finite element simulations to solve each of the plurality of different types of subdomains.

In some implementations, the deep learning model is one of a plurality of deep learning models, wherein the instructions further cause the system to: train the plurality of deep learning models, wherein each of the plurality of deep learning models is trained to predict a response of a unique type of subdomain.

In some implementations, the plurality of deep learning models are trained using respective training data sets, wherein each of the training data sets includes at least one of midline horizontal and vertical displacements or the whole displacement field, subdomain geometry, material properties, and boundary conditions for a respective unique type of subdomain.

In some implementations, the plurality of deep learning models are trained using respective training data sets, wherein each of the training data sets includes at least one of subdomain geometry, material properties, displacements along planes parallel to X-Y, X-Z, and Y-Z planes or the whole displacement field, subdomain geometry, material properties, and boundary conditions for a respective unique type of subdomain for a 3-dimensional (3D) physical object.

In some implementations, the instructions further cause the system to: identify one of the plurality of deep learning models that is applicable to each of the plurality of subdomains prior to independently solving each subdomain, wherein each of the identified deep learning models is used to solve a respective one of the plurality of subdomains.

In some implementations, the stress field is predicted using a second deep learning model.

In some implementations, the digital model is decomposed into the plurality of subdomains using an overlapping Schwarz method.

In some implementations, the plurality of subdomains overlap by 50%.

In some implementations, the plurality of subdomains overlap by between 10% and 80%.

In some implementations, the deep learning model is a convolutional neural network or Fourier Neural Operator.

In some implementations, the digital model of the physical object is a 2-dimensional (2D) representation of the physical object.

In some implementations, the digital model of the physical object is a 3-dimensional (3D) model representation of the physical object.

In some implementations, the instructions further cause the system to: generate output data for the physical object based at least on the predicted displacement field over the entire domain and/or stress field.

In some implementations, the output data is employed in a computer-aided design system, simulation, or virtual reality system.

In some implementations, a method of simulating the physical behavior of an object is provided. The method can include: obtaining a digital model of the object; decomposing the digital model into a plurality of subdomains, wherein the plurality of subdomains at least partially overlap; independently solving each subdomain of the plurality of subdomains using a deep learning model, wherein the deep learning model is trained to predict horizontal and vertical displacements (or the whole displacement field) for each subdomain of the plurality of subdomains; iteratively update boundary conditions for each of the plurality of subdomains based on the respective predicted horizontal and vertical displacements (or the whole displacement field); and once convergence is achieved, predict at least one of a displacement field or a stress field using the updated boundary conditions for each subdomain of the plurality of subdomains.

In some implementations, a method of simulating the physical behavior of an object is provided. The method can include: obtaining a digital model of the object; decomposing the digital model into a plurality of subdomains, wherein the plurality of subdomains at least partially overlap; independently solving each subdomain of the plurality of subdomains using a deep learning model, wherein the deep learning model is trained to predict a displacement field or solution field (e.g., temperature field, electromagnetic field) for each subdomain of the plurality of subdomains; iteratively update boundary conditions for each of the plurality of subdomains based on the respective predicted displacement fields or solution fields; and once convergence is achieved, predict at least one of a displacement field over the entire domain, a solution field over the entire domain, or a stress field using the updated boundary conditions for each subdomain of the plurality of subdomains.

In some implementations, a non-transitory computer-readable medium is provided. The non-transitory computer-readable medium has instructions stored thereon that when executed by a processor, cause a computing device to: obtain a digital model of a physical object; decompose the digital model into a plurality of subdomains, wherein the plurality of subdomains at least partially overlap; independently solve each subdomain of the plurality of subdomains using a deep learning model, wherein the deep learning model is trained to predict horizontal and vertical displacements (or the whole displacement field) for each subdomain of the plurality of subdomains; iteratively update boundary conditions for each of the plurality of subdomains based on the respective predicted horizontal and vertical displacements (or the whole displacement field); and once convergence is achieved, predict at least one of a displacement field or a stress field using the updated boundary conditions for each subdomain of the plurality of subdomains.

### BRIEF DESCRIPTION OF THE DRAWINGS

FIG. 1 is a block diagram of an example computing device, according to some implementations.

FIG. 2 is a flow chart of a process for simulating the physical behavior of an object using a digital model, according to some implementations.

FIGS. 3A-3B are schematic diagrams illustrating domain partitioning and updating Boundary Conditions (BCs) of a subdomain in non-overlapping and overlapping domain decomposition (DDM) based on the field approximated in neighboring subdomains, according to some implementations.

FIGS. 4A-4C are schematic diagrams illustrating the approximation of the field in a porous domain using both the non-overlapping and overlapping DDM techniques, according to some implementations.

FIGS. 5A-5B are graphs illustrating the effect of the number of subdomains and the overlap percentage between neighboring subdomains in the overlapping DDM.

FIG. 6 is a schematic diagram illustrating using subdomains with 50% overlap to discretize a domain in the Deep Learning-Driven Domain Decomposition (DLD³) method, according to some implementations.

FIG. 7 are schematic diagrams illustrating partitioning a domain with arbitrary geometry and BCs for the DLD³ method, according to some implementations.

FIG. 8 are schematic diagrams illustrating subdividing a domain into overlapping subdomains, according to some implementations.

FIG. 9A shows an example of a virtually reconstructed geometrical model.

FIG. 9B depicts a small portion of the conforming mesh generated using Conforming to Interface Structured Adaptive Mesh Refinement (CISAMR).

FIGS. 10A-10B are schematic diagrams showing the Finite Element (FE) approximation of displacement and strain fields in the y-direction for the domain and the corresponding mesh generated using the CISAMR algorithm shown in FIGS. 9A-9B.

FIG. 11 is a schematic diagram illustrating extracting random subdomain geometries and the corresponding field/BC as entries into the training dataset, according to some implementations.

FIGS. 12A-12D are schematic diagrams illustrating four different Fourier Neural Operator (FNO) models trained based on the subdomain geometry and applied BC, according to some implementations.

FIG. 13 is a flowchart diagram illustrating a method for extracting random subdomain geometries and the corresponding field/BC as entries into the training dataset, according to some implementations.

FIG. 14 is a graph depicting training and validation losses plotted against the number of epochs during the training of the FNO model.

FIG. 15 is a schematic diagram that shows FNO prediction of the magnitude of the displacement field in several subdomains and the corresponding distribution of the error vs finite element (FE) simulation of the field using conforming meshes.

FIGS. 16A-16B are schematic diagrams corresponding with a first problem in a conducted study.

FIGS. 17A-17C are results for the first problem from the conducted study.

FIGS. 18A-18B are schematic diagrams corresponding with a second problem in a conducted study.

FIGS. 19A-19C illustrate results for the second problem from the conducted study.

FIGS. 20A-20B are schematic diagrams corresponding with a third problem in a conducted study.

FIGS. 21A-21B show results for the third problem from the conducted study.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a system and methods for simulating the physical behavior of objects are shown, according to various implementations. As used herein, “physical behavior” generally refers to a mechanical response, thermal response, chemical response, or the like for an object. In some implementations, the system and methods disclosed herein relate to an artificial intelligence (AI)-driven modeling technique for modeling the response/behavior of physical objects within a digital environment. At a high level, digital models of physical objects are processed using a domain decomposition method (DDM) model configured to solve a boundary value problem by splitting the digital model into a plurality of subdomains (e.g., smaller boundary value problems on subdomains). Each subdomain can then be individually solved (e.g., as a partial differential equation) using a deep learning model to predict horizontal and vertical displacements (or the whole displacement field), which in turn can be used to predict boundary conditions for the respective subdomain. From the respective boundary conditions, a displacement field and/or a stress field can be predicted.

This technique—sometimes referred to herein as DLD³—can address several disadvantages of FEM as described above, as well as limitations of various other AI techniques for predicting the physics-based response of problems with arbitrary geometry and boundary conditions. For example, DLD³ can result in: 1) reduced labor cost associated with the modeling process—for example, no need for mesh generation; 2) reduced computational cost; 3) enabling the simulation of massive problems not feasible using existing computational resources and FE-based algorithms; and 4) addresses the challenges associated with the generalizability of AI models to problems with arbitrary shapes and boundary conditions. Notably, DLD³ can be used to simulate a variety of response problems for an object, including but not limited to mechanical, thermal, and chemical responses. For example, in addition to linear elasticity, which is discussed in detail herein as an example, DLD³ can also be applied to transient heat transfer problems, plasticity problems, and so on. In addition, it should be appreciated that DLD³ can be applied to both 2-dimensional (2D) and three-dimensional (3D) digital models.

The Deep Learning-Driven Domain Decomposition (DLD³) algorithm described herein is a generalizable Artificial Intelligence (AI)-driven technique for simulating two-dimensional linear elasticity problems with arbitrary geometry and boundary conditions (BCs). In some implementations, DLD³ uses a set of pre-trained AI models capable of predicting the linear elastic displacement field in small subdomains of a given domain with various geometries/BCs. The overlapping Schwarz domain decomposition method (DDM) is then utilized to iteratively update the subdomain BCs to approximate the problem response by enforcing a continuous displacement field in the domain. In some implementations, the Fourier Neural Operator (FNO) model was chosen as the AI engine used in the DLD³ algorithm due to its data efficiency and high accuracy. This disclosure contemplates that other model architectures can be used. This disclosure presents a framework relying on geometry reconstruction and automated meshing algorithms to acquire millions of data used for training these FNO models based on high-fidelity finite element (FE) simulation results. Several example problems are presented to demonstrate the ability of the DLD³ algorithm to accurately predict the displacement field in problems with complex geometries and with different BCs and material properties.

The Finite Element Method (FEM) and commercial finite element software are widely used to simulate the thermal and mechanical behaviors of materials/structures across various industries, such as automotive, aerospace, and defense. However, given the fact that the underlying algorithms used in these software programs have seen little change over the past decades, the operational and computational costs associated with performing FE simulations could be significant. These challenges often result in compromises such as the oversimplification of the problem geometry/microstructure, using coarse meshes, or minimizing the number of simulations, which undermine the fidelity of results. The high operational cost of an FE analysis primarily stems from the intricate and time-consuming process of setting up the model, involving tasks such as drawing accurate computer-aided design (CAD) models and creating conforming meshes. Addressing the latter remains an active research area, especially for problems featuring complex or evolving morphologies. Furthermore, tackling complex problems such as the design of a hydraulic manifold or simulating the multiscale response of composite structures, demands substantial expertise to ensure accurate FE model setup by careful selection of modeling parameters like the element type/quality and the mesh refinement level. It is also evident that the computational cost of solving large-scale FE problems, comprising tens of millions of elements, can be overwhelming. This poses a significant barrier to conducting an adequate number of simulations within real-world design constraints where time is of the essence, such as designing an aircraft fuselage subject to various loading conditions. Moreover, limitations in the underlying algorithms and compute resources do not allow the direct numerical simulation (DNS) of massive problems requiring billions of elements in the FE mesh [1], necessitating the use of less accurate techniques such as homogenization or multiscale methods (e.g., the FE2 concurrent multiscale method) [2, 3, 4]. Consequently, there is a pressing need for advancements that alleviate these computational challenges and streamline the simulation process, while preserving accuracy and incorporating uncertainty factors efficiently.

Recently, scientific AI/ML has gained significant attention as a surrogate for numerical techniques in the fields of computational solid and fluid mechanics for applications such as the virtual reconstruction of material microstructures [5, 6], linking the microstructure to properties [7, 8, 9, 10, 11], predicting the material/fluid response (stress field, velocity field, etc.) [12, 13, 14, 15], and multiscale simulations [16]. Artificial neural networks (ANNs) have been the first AI/MIL models for structural optimization and material homogenization [17, 18]. In early studies, the lack of computational resources for training ANNs resulted in restricting the number of input variables, the size of the network, and therefore the predictive capability of such models. With the increase in computing power and advanced Graphics Processing Units (GPUs), deep neural networks (DNNs) have enabled the processing of many parameters for modeling complex, nonlinear relationships between input and output variables [19]. Combined with techniques such as principal component analysis (PCA) [20], deep belief networks (DBN) [21], and deep autoencoders [22], which produce a lower-dimensional representation of the data, the most important features of the data can be easily identified. This enables a DNN model to better learn the inherent relationships, and hence serve as a surrogate for numerical analysis upon proper training.

The convolutional neural networks (CNN) [23, 24, 25] are a class of DL algorithms extensively used for linking material microstructures to their mechanical behaviors. CNNs provide an end-to-end framework, from the image of a material microstructure to its properties without intermediate operations. Therefore, a trained CNN model usually exhibits a higher level of generalization and remarkable potential for solving challenging problems in materials science [8]. Unlike CNNs, generative adversarial networks (GANs) are unsupervised learning algorithms wherein two neural networks (discriminator and generator) compete against one another in a zero-sum game [26]. The ability to create realistic fake images has made GANs an attractive choice for the reconstruction of material microstructures [27]. CNN-based encoder-decoder models (U-Net) and GANs have also been used for predicting the stress/strain fields when the domain geometry is given as the input [28, 29]. Recurrent neural networks (RNNs) [30], including long short-term memory (LSTM) and gated recurrent units (GRU), have extensively been used for predicting the response of nonlinear problems such as damage and plasticity [31, 32].

The AI/ML models mentioned above were originally developed in other areas of research such as computer vision and natural language processing and then applied to various problems in solid/fluid mechanics. There is also another class of AI/ML models specifically developed for predicting the response of partial differential equations, among which physics-informed neural networks (PINNs) [12, 10, 15] is one of the most successful techniques for modeling a wide array of problems. PINNs offer the ability to simulate complex phenomena using a small set of training data by embedding prior knowledge of physical laws (boundary conditions, stress-strain relationships, etc.) in the training process to enhance the data set and facilitate learning. They are successfully applied to bioinformatics [33], power systems [34], chemistry [35], free surface flows [36], linear elasticity [37, 38], multi-physics additive manufacturing [39], and many other types of mechanics problems. More recently, the Fourier neural operator (FNO) [13, 14] has shown superior performance and data efficiency compared to classical AI/ML models such as CNN for simulating mechanics problems. The FNO directly learns an infinite-dimensional mapping from any functional parametric dependence to the solution by implementing a fast Fourier transform (FFT) kernel. Like PINNs, the original FNO model and its variants (implicit FNO [40], domain agnostic FNO [41], geometry informed FNO [42], convolutional FNO [43], UNet-enhanced FNO [44], etc.) have been implemented for predicting the response of a wide range of linear and nonlinear mechanics problems.

The works cited above, among many others, have shown that scientific AI/ML models can effectively address the high operational and computational costs associated with the application of numerical methods such as FEM. However, the prospect of utilizing such models as a substitute for FE software applied to modeling problems with arbitrary geometry and boundary conditions (BCs) is diminished by two major limitations:

Trainability: The overwhelming cost of obtaining the data needed to train an AI/ML model could be a bottleneck in many projects, as tens of thousands or millions of labeled data might be needed depending on the complexity of the system. In scientific ML applications, these data are often obtained from numerical simulations such as FEM, requiring the ability to automatically create a large number of geometrical models and their corresponding conforming meshes, followed by approximating the field in each model to build the training dataset. The training process, i.e., the selection of the optimal network architecture and tuning its hyperparameters, is also a time-consuming process requiring significant computing power (GPU resources). In applications involving a training dataset composed of millions of entries, the high computational cost associated with this phase could be significantly higher than the cost of acquiring the training data.

Generalizability: Given the enormous cost and challenges associated with the training process, a more notable limitation of scientific ML models is the lack of generalizability to problems outside the range of training data. For example, as shown in an earlier study by the authors of this manuscript [45], a squeeze-and-excitation residual network (SE-ResNet) model is trained with tens of thousands of high-fidelity FE simulation results to accurately predict the strength and toughness of a steel pipe subjected to pitting corrosion. Besides highly facilitating the modeling process by directly predicting the mechanical integrity based on an image of the pipe surface, this SE-ResNet model was shown to yield approximately 5 orders of magnitude speedup compared to an FE simulation. However, even for the same material, this model fails to accurately predict the impact of other types of defects such as porosity defects emerging during the additive manufacturing process or even corrosion attacks with significantly different shapes in the same pipe. Likewise, the model presented in [45] is only trained for one type of BC, thus considering other loading conditions requires re-training the model and dealing with the trainability challenges discussed previously. There are myriads of similar examples in the literature, where although a scientific ML model is successfully applied to a specific problem, it cannot be generalized to a wider class of problems.

Embodiments of the present disclosure provide a generalizable AI-driven modeling technique, coined Deep Learning-Driven Domain Decomposition (DLD³), for simulating two-dimensional linear elasticity problems with arbitrary geometry and boundary conditions (BCs). In this approach, a set of pre-trained AI/ML models capable of accurately predicting the displacement field in small subdomains of a larger problem with various geometries/BCs are deployed in the Schwarz overlapping domain decomposition method (DDM) to approximate the linear elastic response. A thorough preliminary study was conducted comparing various AI/ML models for predicting the displacement field, resulting in the selection of the FNO model. While FNO is more data-efficient compared to models such as CNN, large variations in the geometry and applied BC along subdomain boundaries necessitate the use of a large dataset with millions of entries for training the FNO models used in this work. We implement an integrated modeling framework, relying on a geometric engine for reconstructing thousands of domains with distinct morphologies [46] and an automated mesh generation algorithm, named Conforming to Interface Structured Adaptive Mesh Refinement (CISAMR) [47, 48], to create thousands of high-quality, refined FE meshes and simulate their linear elastic response subject to varying BCs. The training dataset is then constructed by extracting millions of subdomains (images) and their corresponding displacement fields and BCs, as well as material property fields (elastic modulus and Poisson's ratio) from the simulation results. Several examples are provided in this work to show that, after training the FNO models with this dataset extracted from high-fidelity FE simulations, the DLD³ method can predict the response of a wide array of problems with distinct geometries and BCs. A brief overview of the overlapping and non-overlapping DDM techniques is provided herein, where we also discuss the reasoning for using the former in the DLD³ technique. We delve into the DLD³ algorithm and provide a detailed discussion on constructing the training dataset and the subsequent training/performance of the FNO models used in this method. Several examples are provided herein, where we demonstrate the accuracy and generalizability of DLD³ by comparing the predictions made using this technique vs FE simulation results. In some implementations, embodiments described herein can be employed to generate simulation data for various applications, including computer-aided design (CAD) systems and virtual reality (VR) systems.

Setting up a DLD³ model will not involve mesh generation or specifying any modeling parameter by the user. The only inputs are an image of the domain and BCs. While the DLD³ algorithm uses an iterative solver (even for linear elasticity) to approximate the problem response, the AI models used to predict the field in each subdomain are orders of magnitude faster than FEM, resulting in an overall reduction in the computational cost. While the cost of training the AI models used in the proposed DLD³ algorithm is high, this cost is only incurred once, and the resulting model can handle problems with arbitrary geometry and BCs. By eliminating the need for mesh generation, DLD³ directly uses imaging data such as micro-CT and ultrasonic images to perform a simulation, which is highly suitable for applications such as modeling porosity defects in additively manufactured parts and structures subjected to corrosion attack. The DLD³ algorithm has the potential to perform massive simulations without running into issues such as convergence difficulty or lack of memory observed in FE.

Embodiments of the present disclosure solve various challenges including those associated with accurate approximation of the field near curved edges and material interfaces. The proposed system can be embodied as standalone software or potentially as an add-on for FEM software. DLD³ can specifically be tuned for simulating the digital manufacturing of flexible parts such as wire harnesses in real time. Given the high computational cost associated with FEM, existing digital manufacturing software packages use either coarse meshes or rely on alternative techniques such as reduced-order models, which essentially compromise the accuracy. The ability to simulate a physical phenomenon in real-time opens the door to using DLD³ as the underlying simulation engine in augmented/virtual reality software, where the simulations are often not physics-based. The applications range from training purposes to use in video games to provide a more realistic environment. Further, DLD³ can significantly enhance the predictive maintenance (e.g., of the aging Air Force fleet) based on non-destructive inspection data such as imaging via automated physics-based simulations.

In some examples, outputs generated via the DLD³ methods described herein can be used to generate 2D or 3D models or objects that a user can manipulate directly in a CAD design, simulation, or VR environment (for example, to apply forces to the generated object in the context of solving an engineering design problem). Embodiments of the present disclosure can be variously employed in structural analysis (e.g., buildings, aircraft, mechanical components) including vibrational and acoustic analysis, fluid dynamics and computational fluid dynamics, and electronic device design (e.g., motors, circuits, transformers) to predict the performance of objects and as part of product development and testing. For example, DLD³ can be used to simulate material response using raw imaging data as the only input which highly reduces the operational costs and computational costs of such systems.

### Example Computing Device

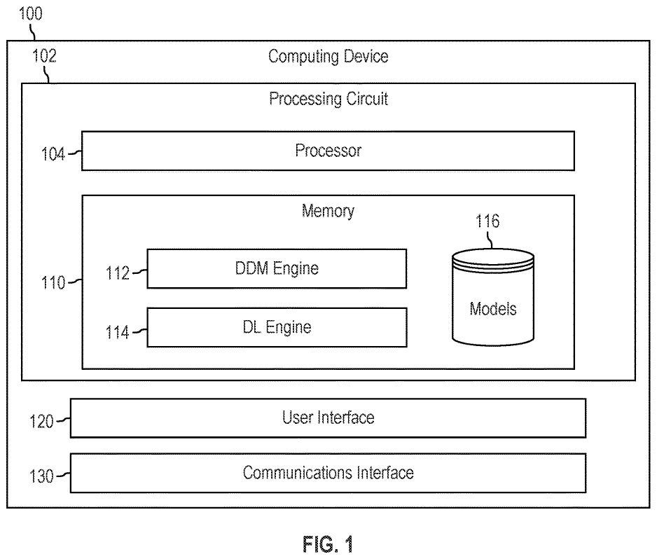

Referring to FIG. 1, an example computing device 100 is shown, according to some implementations. Computing device 100 may be generally configured to implement or execute the various processes and methods described herein. Computing device 100 may be any suitable computing device, such as a desktop computer, a laptop computer, a server, a workstation, a smartphone, or the like. Computing device 100 generally includes a processing circuit 102 that includes a processor 104 and a memory 110. Processor 104 can be a general-purpose processor, an ASIC, one or more FPGAs, a group of processing components, or other suitable electronic processing structures. In some embodiments, processor 104 is configured to execute program code stored on memory 110 to cause computing device 100 to perform one or more operations, as described below in greater detail. It will be appreciated that, in embodiments where computing device 100 is part of another computing device (e.g., a general-purpose computer), the components of computing device 100 may be shared with, or the same as, the host device. In some implementations, the computing device 100 is embodied as or in electronic communication with a CAD system, VR system, or a simulator/simulation system.

Memory 110 can include one or more devices (e.g., memory units, memory devices, storage devices, etc.) for storing data and/or computer code for completing and/or facilitating the various processes described in the present disclosure. In some embodiments, memory 110 includes tangible (e.g., non-transitory), computer-readable media that store code or instructions executable by processor 104. Tangible, computer-readable media refers to any physical media that can provide data that causes computing device 100 to operate in a particular fashion. Example tangible, computer-readable media may include, but is not limited to, volatile media, non-volatile media, removable media, and non-removable media implemented in any method or technology for storage of information such as computer-readable instructions, data structures, program modules, or other data. Accordingly, memory 110 can include RAM, ROM, hard drive storage, temporary storage, non-volatile memory, flash memory, optical memory, or any other suitable memory for storing software objects and/or computer instructions. Memory 110 can include database components, object code components, script components, or any other type of information structure for supporting the various activities and information structures described in the present disclosure. Memory 110 can be communicably connected to processor 104, such as via processing circuit 102, and can include computer code for executing (e.g., by processor 104) one or more processes described herein.

While shown as individual components, it will be appreciated that processor 104 and/or memory 110 can be implemented using a variety of different types and quantities of processors and memory. For example, processor 104 may represent a single processing device or multiple processing devices. Similarly, memory 110 may represent a single memory device or multiple memory devices. Additionally, in some embodiments, computing device 100 may be implemented within a single computing device (e.g., one server, one housing, etc.). In other embodiments, computing device 100 may be distributed across multiple servers or computers (e.g., that can exist in distributed locations). For example, computing device 100 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by two or more computers. For example, virtualization software may be employed by computing device 100 to provide the functionality of a number of servers that is not directly bound to the number of computers in computing device 100.

Memory 110 is shown to include a domain decomposition (DDM) engine 112 configured to decompose digital models (e.g., 2D or 3D representations) of physical objects into a plurality of subdomains. Memory 110 is also shown to include a deep learning (DL) engine 114 configured to solve each subdomain generated by DDM engine 112. More generally, as described herein, DDM engine 112 and DL engine 114 may operate cooperatively to decompose a digital model into subdomains, solve each subdomain, and iteratively update boundary conditions for each subdomain. In addition, DDM engine 112 and/or DL engine 114 may be configured to predict a linear-elastic response for each subdomain, for example, displacement and/or stress fields from the solved subdomains and/or updated boundary conditions.

DDM engine 112, in particular, may be configured to implement an overlapping DDM technique to generate a plurality of overlapping subdomains. In some implementations, the overlapping DDM technique is the overlapping Schwarz method. In some implementations, DDM engine 112 generates a plurality of subdomains that overlap by 50%. After decomposing the digital model into a plurality of overlapping subdomains, DL engine 114 may solve each subdomain (e.g., as partial differential equation problems) to predict horizontal and vertical displacements (or the whole displacement field). In the case of a 50% overlap of each subdomain, DL engine 114 may predict midline horizontal and vertical displacements. The predicted displacements can then be used to update boundary conditions for each of the subdomains and/or to predict a displacement and/or stress field.

In some implementations, DL engine 114 solves each subdomain using a single, pre-trained deep learning model. The deep learning model may be a convolution neural network or a Fourier Neural Operator; however, it will be appreciated that other suitable types of deep learning models can be used. In some implementations, the deep learning model is stored in a database 116 of memory 110. In some implementations, DL engine 114 is configured to train the deep learning model to solve a plurality of different types of subdomains. Alternatively, the deep learning model may be trained by a remote computing device and later transmitted to or retrieved by DL engine 114 for use. In either case, the deep learning model may be trained to predict the response of a variety of different types of subdomains using a training data set.

In some implementations, DL engine 114 solves for each subdomain using a dedicated or separate deep learning model. In other words, a plurality of deep learning models can be trained, each to solve a different type of subdomain. In some implementations, DL engine 114 or a remote device can train the plurality of deep learning models using respective training data sets. For example, multiple different neural networks (NNs), CNNs, FNOs, or other suitable models may be trained using respective training data sets. In some implementations, each training data set is associated with a particular type of subdomain problem.

Whether single or multiple deep learning models are trained, training data may be generated using similar methods. In some implementations, for 2D problems, each training data set includes the subdomain geometry, material properties, displacement/traction boundary conditions (input data), and horizontal and vertical displacements or the whole displacement field (output data or label data) for a respective type of subdomain. In some implementations, for 3D problems, each of the training data sets includes the subdomain geometry, material properties, displacements along planes parallel to X-Y, X-Z, and Y-Z planes (or the whole displacement field) and displacement/traction boundary conditions for a respective unique type of subdomain. In some implementations, the training data sets are generated using FE-DDM simulations. In some implementations, the training data sets are generated using finite element (FE) simulations to solve each of the plurality of different types of subdomains. In some such implementations, a large number of FE simulations may be conducted on multiple subdomains with various geometries and boundary conditions. This disclosure contemplates that the solution fields described herein are not limited to displacement fields for linear elastic problems and can include or refer to other data types and solution fields for various problems including non-linear problems. For example, this disclosure contemplates that the system and methods described herein can be used to determine temperature fields for heat transfer problems and electromagnetic fields for electrical problems.

In some implementations, training each deep learning model includes: providing, to a deep learning model that is being trained, boundary conditions at multiple boundary points (e.g., 80 points, 21 along each boundary in 2D) for a subdomain. In some implementations, the boundary conditions relate to a specific type of subdomain that the deep learning model is being trained to evaluate. The deep learning model then predicts displacements along the horizontal and vertical midlines (or the whole displacement field) of the subdomain. A polynomial curve can then be fitted to the resulting midline displacement values to extrapolate points for updating the adjacent subdomain boundary conditions during DDM iterations.

In some implementations, DL engine 114 is further configured to identify one of the plurality of deep learning models that is applicable to each of the plurality of subdomains prior to independently solving each subdomain. For example, multiple trained deep learning models may be stored in database 116 such that DL engine 114 can identify a type of each subdomain, retrieve the appropriate model(s) from database 116, and solve each subdomain with the appropriate deep learning model. In some implementations, DL engine 114 can further execute a model to predict a stress field and/or displacement field based on the predicted horizontal and vertical displacements (or the whole displacement field) for each subdomain.

The term “artificial intelligence” is defined herein to include any technique that enables one or more computing devices or comping systems (i.e., a machine) to mimic human intelligence. AI includes but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural networks or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, output layer, and optionally one or more hidden layers. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., an error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

A CNN, as mentioned above, is a type of deep neural network that has been applied, for example, to image analysis applications. Unlike traditional neural networks, each layer in a CNN has a plurality of nodes arranged in three dimensions (width, height, and depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully connected layer includes neurons, where each neuron is connected to all of the neurons in the previous layer. The layers are stacked similar to traditional neural networks.

In some implementations, computing device 100 further includes a user interface 120 that enables a user to interact with computing device 100. In particular, user interface 120 may include a screen, such as an LED or LCD screen, that can display data, text, and other graphical elements to a user. For example, user interface 120 may include a screen on which digital models of objects are displayed. In some implementations, user interface 120 includes one or more user input devices, such as a mouse, a keyboard, a joystick, a number pad, a drawing pad or digital pen, a touch screen, and the like. These user input device(s) are generally configured to be manipulated by a user to input data to, or to otherwise interact with computing device 100. For example, computing device 100 may include a mouse and/or keyboard that a user can use to input, retrieve, and/or manipulate digital models.

Computing device 100 is also shown to include a communications interface 130 that facilitates communications between computing device 100 and any external components or devices. For example, communications interface 130 can facilitate communications between computing device 100 and a back-end server or other remote computing device. In some implementations, communications interface 130 also facilitates communications to a plurality of external user devices. Accordingly, communications interface 130 can facilitate communications between communications interface 130 can be or can include a wired or wireless communications interface (e.g., jacks, antennas, transmitters, receivers, transceivers, wire terminals, etc.) for conducting data communications, or a combination of wired and wireless communication interfaces. In some embodiments, communications via communications interface 130 are direct (e.g., local wired or wireless communications) or via a network (e.g., a WAN, the Internet, a cellular network, etc.). For example, communications interface 130 may include one or more Ethernet ports for communicably coupling computing device 100 to a network (e.g., the Internet). In another example, communications interface 130 can include a Wi-Fi transceiver for communicating via a wireless communications network. In yet another example, communications interface 130 may include cellular or mobile phone communications transceivers.

### Example Method

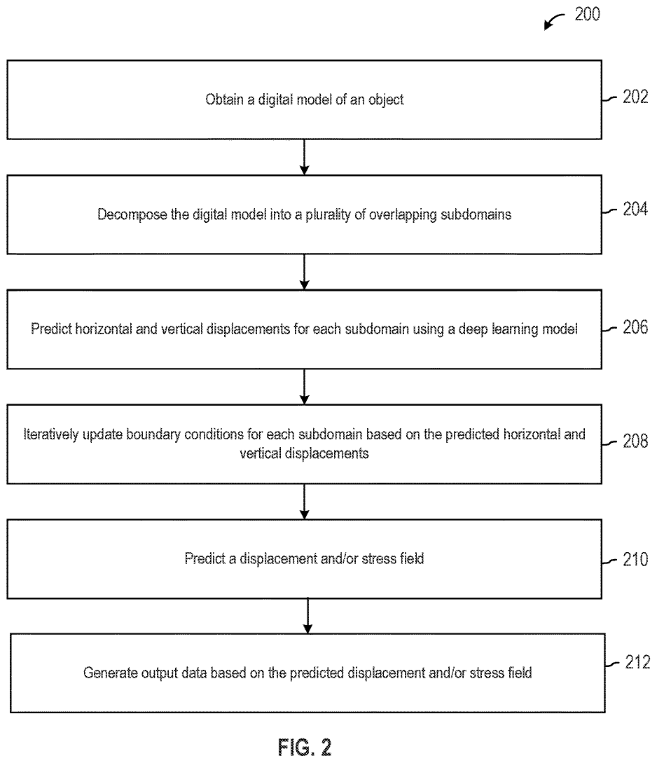

Referring now to FIG. 2, a flow chart of a process 200 for simulating a physical behavior (e.g., mechanical response, thermal response, chemical response, etc.) of an object from a digital model is shown, according to some implementations. In some implementations, process 200 can be used to predict the linear elastic response of an object; however, it should be appreciated that process 200 can more generally be applied to any physical response problem, for example, mechanical, thermal, chemical, etc. In some implementations, process 200 is implemented by computing device 100, as described above. However, it should be understood that process 200 can, more generally, be implemented or executed by any suitable computing device. It will be appreciated that certain steps of process 200 may be optional and, in some implementations, process 200 may be implemented using less than all the steps. It will also be appreciated that the order of steps shown in FIG. 2 is not intended to be limiting.

At step 202, a digital model of a physical object is obtained. Generally, the digital model can be either a 2D or 3D model of the physical object. In some implementations, the digital model is retrieved from a database, downloaded from a media device (e.g., a portable memory device), or otherwise obtained by a user of computing device 100. In some implementations, the digital model can be created and/or stored locally on computing device 100.

At step 204, the digital model is decomposed into a plurality of overlapping subdomains. In particular, a DDM model may be applied to the digital model to generate the subdomains. In some implementations, the DDM model implements an overlapping Schwarz method to decompose the digital model. In some implementations, the plurality of subdomains overlap by 50%, which can enhance the DDM solver convergence and facilitate training the DL model; however, it should be appreciated that in various other implementations, the subdomains may overlap by any amount (e.g., 10%, 20%, 30%, 40%, 50%, 60%, 70%, 80% etc.). It should also be appreciated that using a nonoverlapping DDM technique is not always feasible due to the sensitivity of the solver to the accuracy of tractions exchanged along subdomain boundaries. However, a non-overlapping DDM might be used when solving multiphase problems (similar to fluid-solid interaction or modeling a two-phase composite material).

At step 206, each subdomain is solved using a suitable deep learning model to predict vertical and horizontal displacements or the whole displacement field (e.g., for a 2D subdomain). As mentioned above, in some implementations, a single deep learning model (e.g., a CNN) is trained to predict displacement values for any type of subdomain. However, in other implementations, a plurality of different deep learning models are trained, each to predict displacement values for a particular type of subdomain. In implementations where the subdomains overlap by 50%, the deep learning model(s) may be configured to directly predict midline horizontal and vertical displacements or the whole displacement field and then extract midline horizontal and vertical displacements.

At step 208, boundary conditions for each of the subdomains are iteratively updated based on the predicted displacements. In particular, the boundary conditions along each subdomain boundary may be iteratively updated to enforce the continuity of forces/displacements. In some implementations, the boundary conditions are iteratively updated until convergence is achieved (e.g., via the Schwarz DDM).

At step 210, a displacement field and/or a stress field are predicted. In particular, a displacement and/or stress field can be predicted based on the updated boundary conditions from step 208, for example, after convergence. In some implementations, the displacement field is predicted based on the updated boundary conditions and geometry of each subdomain. In some such implementations, these data points (e.g., the updated boundary conditions and geometry of each subdomain) are provided as inputs to a deep learning model. In some implementations, the deep learning model is different from the deep learning model(s) used to predict the horizontal and vertical displacements (midline horizontal and vertical displacements). For example, the deep learning model for predicting the displacement field may be a different type of deep learning model and/or may be trained on a different data set to make different predictions (e.g., predictions of a displacement field instead of predictions of horizontal and vertical displacements).

In some implementations, the stress field is predicted from the displacement field. In some such implementations, a geometry of each subdomain is provided as input to a deep learning model for predicting the stress field. In some implementations, hierarchical deep learning predictions are initiated to recursively evaluate the displacement along the midline of each subdomain, and then on the midlines of its quarter subdomains, etc., until the full displacement field is determined. In some cases, the deep learning model is trained to predict an entire displacement field. In some such implementations, the displacement field is simply predicted/visualized for all subdomains. In some implementations, a stress field can be recovered from the resulting displacement values. In other implementations, a second deep learning model is trained to predict the stress field from the boundary displacements and/or the displacement field.

At step 212, output data is generated for the physical object, for example, based at least in part on the predicted displacement field over the entire domain and/or stress field. In various implementations, the generated output data can be employed in a computer-aided design system, simulation, or virtual reality system. In some implementations, the output data is used to generate user interface data (e.g., models, image data, simulation data, renderings, or the like) depicting the predicted displacement field and/or stress field. In some implementations, the output data can include new training data for machine learning model(s).

### Overview of Domain Decomposition Method (DDM) Techniques

The DLD³ technique relies on the utilization of DDM to break down a large domain into smaller subdomains, the response of which can accurately be predicted using a pre-trained ML model, to approximate the displacement field. Before delving into various aspects of the DLD³ algorithm, it is crucial to provide a brief overview of the non-overlapping and overlapping DDMs and clarify why a special format of the latter with 50% overlap between neighboring subdomains, is deployed in DLD³. It must be noted that the discussions that follow are mostly adapted from an earlier study by Yang and Soghrati [49] on the performance of overlapping and non-overlapping FE-DDM (using FEM to approximate the field in each subdomain) for simulating the linear elastic and elastoplastic responses of problems with complex geometries.

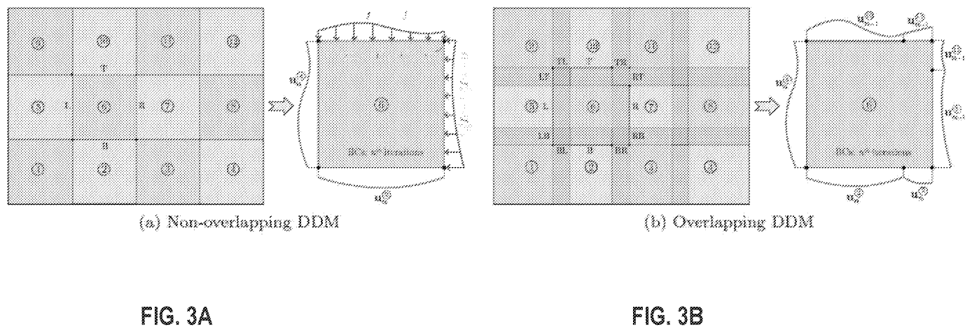

FIGS. 3A-3B illustrate domain partitioning and updating BCs of a subdomain in non-overlapping (FIG. 3A) and overlapping DDM (FIG. 3B) based on the field approximated in neighboring subdomains. The core idea of both the non-overlapping and overlapping DDM is to approximate the field in each subdomain independently (e.g., using FEM) and use this solution to update BCs of neighboring subdomains. This process is iteratively continued until the continuity of the field (and tractions in the non-overlapping DDM) is satisfied over the entire domain. The first step of the modeling process for a DDM simulation is to subdivide the domain into smaller subdomains, as shown in FIGS. 3A-3B. Since we are interested in modeling problems with arbitrary domain geometry, the structured partitioning scheme shown in this figure is utilized to generate the subdomains and the connectivity between them. Next, one must initialize the BCs along with subdomain edges. While one could simply initialize all BCs as zero, this approach would increase the number of iterations needed to enforce the continuity conditions and thereby increase the overall simulation time. A better approach is to initialize BCs using a reasonable estimate of the solution, which could be obtained from the field approximated on a very coarse, pixelated mesh [49]. More details on the algorithms used for updating BCs and other implementation aspects of the non-overlapping and overlapping DDMs for modeling linear elasticity problems are provided below.

### Non-Overlapping Schwarz DDM

In a non-overlapping DDM simulation, the field approximated in each subdomain \textcircled{1} subject to initial BCs is utilized to update its neighboring subdomain BCs using the fixed-point iteration (FPI) algorithm. In a structured partitioning scheme (cf. FIG. 3A), Dirichlet (displacement) BC is enforced along the left and bottom edges of each subdomain, while the right and top edges have Neumann (traction) BC. In a sequential DDM simulation, the iterative FPI process begins by approximating the field in subdomain \textcircled{1} and using this solution to update the Dirichlet BCs along the left edge of \textcircled{2} and the bottom edge of \textcircled{5}.

We then approximate the field in \textcircled{2} and use that to update the Dirichlet BCs along the left and bottom edges of \textcircled{3} and \textcircled{6}, respectively, as well as the Neumann BC along the right edge of \textcircled{1}. This process is iteratively continued by performing multiple passes on all subdomains until the continuity of displacements and tractions along the edges of neighboring subdomains are satisfied, i.e., until the difference between BC along a subdomain edge and that recovered from its neighboring subdomain is less than a user-defined threshold tol_{ū} and tol_{t̅} as

$${E}_{\overline{u}} = \frac{‖ {\overline{u}}_{n + 1} - {\overline{u}}_{n} ‖}{‖ {\overline{u}}_{n} ‖} < {tol}_{\overline{u}} , {E}_{\overline{t}} = \frac{‖ {\overline{t}}_{n + 1} - {\overline{t}}_{n} ‖}{‖ {\overline{t}}_{n} ‖} < {tol}_{\overline{t}} . \qquad ( 1 )$$

In this equation, ūₙ and t̅ₙ are the nodal vectors of displacement and traction BCs along subdomain edges at iteration n.

To describe the FPI algorithm employed to update the subdomain BCs in the non-overlapping DDM, consider the shared edge between neighboring subdomains \textcircled{1} and \textcircled{2}, as shown in FIG. 3A. After approximating the field in \textcircled{1} at iteration n, the nodal displacement vector ūₙ \textcircled{1} evaluated along the right edge of this subdomain directly updates the displacement BC along the left edge of \textcircled{2} for iteration n+1 as

$$\text{?} = \text{?} . \qquad ( 2 )$$

Updating the traction BC along the right edge of \textcircled{1} after approximating the field in \textcircled{1}, however, requires using an under-relaxation approach to ensure the convergence of the DDM simulation. Using the relaxation factor β<1, a small portion of the traction BC recovered along the left edge of \textcircled{2} updates the existing traction vector t̅ₙ along the right edge of \textcircled{1} for the next iteration as

$$\text{?} = ( 1 - β ) \text{?} - \text{?} , \qquad ( 3 )$$

While updating subdomain Dirichlet BCs in the FPI algorithm is a straightforward task, using the under-relaxation approach to update Neumann BCs requires special care to avoid convergence issues. First, several special cases must be taken into account to ensure these BCs are correctly updated during DDM iterations, as inaccurate updating of tractions at even one node could jeopardize convergence. For example, the traction at the upper right corner of \textcircled{6} in FIG. 3A must be updated based on contributions from all its neighboring subdomains as

$$\text{?} = ( 1 - β ) \text{?} - \text{?} + \text{?} + \text{?} ) . \qquad ( 4 )$$

Other special cases must be considered when the corner node of a subdomain is located along a domain boundary with a prescribed traction BC, as well as cases where mesh nodes of two neighboring subdomains do not match in an FE-DMM simulation.

However, the main implementation issue is attributed to selecting an appropriate value for the relaxation factor β. As shown through several numerical examples in [49], for problems with complex geometries where subdomain edges arbitrarily intersect material interfaces, a very small value of β (β<0.1 or even β<0.05) might be needed to achieve convergence. Since a very small percentage of the traction recovered from a subdomain contributes to updating the traction BC along its neighboring subdomain, such a small value of β could significantly increase the number of DDM iterations and consequently increase the overall simulation time. The value of β is therefore adaptively changed during the DDM iterations to offset this effect, although inevitably the convergence could be very slow for problems with complex geometries. An even bigger challenge could arise when a material interface (or void) intersects the subdomain boundary at an acute angle, which considerably undermines the accuracy associated with the recovery of tractions at the intersection point. Since this additional error affects the updated traction BC in the neighboring subdomain, the non-overlapping DDM often faces convergence issues in such cases. Our extensive numerical studies in [49] showed that for modeling elastoplastic problems, these difficulties are much more pronounced and the non-overlapping DDM often fails to converge when subdomain edges intersect material interfaces or voids, regardless of the intersection angle. These challenges and shortcomings show that the non-overlapping DDM is not a reliable technique to implement in the DLD³ framework for modeling problems with arbitrary geometry, where inevitable intersections between subdomain edges and material interfaces are inevitable, as well as the added error associated with using an AI model to predict the response of each subdomain, could easily prohibit convergence.

### Overlapping Schwarz Method

Compared to the non-overlapping DDM, the overlapping Schwarz method has a more straightforward algorithm that only involves updated Dirichlet BCs of subdomain edges based on the field approximated in its neighboring overlapping subdomains. Therefore, in an overlapping DDM simulation, we no longer require recovering stresses within a subdomain or the tractions along its edges, which not only facilitates the implementation but also improves the accuracy due to the higher error involved in the recovery of gradients (stresses/tractions) vs the field. Further, this algorithm does not require using an under-relaxation approach and therefore determining the appropriate value of R for updating BCs.

Referring to the structured pattern of overlapping subdomains in FIG. 3B, the displacement BCs along the edges of subdomain \textcircled{6} in a sequential overlapping DDM simulation proceeding from subdomain \textcircled{1} to \textcircled{12} are updated as

$$\text{?} = \text{?} {\vert}_{\text{?}} , \text{?} = \text{?} {\vert}_{\text{?}} , \text{?} = \text{?} {\vert}_{\text{?}} , \qquad ( 5 )$$

$$\text{?} = \text{?} {\vert}_{\text{?}} , \text{?} = \text{?} {\vert}_{\text{?}} , \text{?} = \text{?} {\vert}_{\text{?}} ,$$

$$\text{?} = \text{?} {\vert}_{\text{?}} , \text{?} = \text{?} {\vert}_{\text{?}} , \text{?} = \text{?} {\vert}_{\text{?}} ,$$

$$\text{?} = \text{?} {\vert}_{\text{?}} , \text{?} = \text{?} {\vert}_{\text{?}} , \text{?} = \text{?} {\vert}_{\text{?}}$$

$$\text{?} \text{indicates text missing or illegible when filed}$$

Here, the letters “L”, “B”, “R”, and “T” in the superscripts refer to “Left”, “Bottom”, “Right”, and “Top” regions of the subdomain boundary, as labeled in FIG. 3B. Also, the BCs along different regions of the subdomain \textcircled{6} edges are updated based on the order in which the subdomains are being visited to approximate the field in them (from \textcircled{1} to \textcircled{12}) to use the most up-to-date field in this process. For example, although the bottom left (BL) portion of the subdomain \textcircled{6} edge overlaps with both \textcircled{1} and \textcircled{2}, since the field in the latter is simulated last, only the approximated field in \textcircled{2} is utilized to update this portion of the BC in \textcircled{6}.

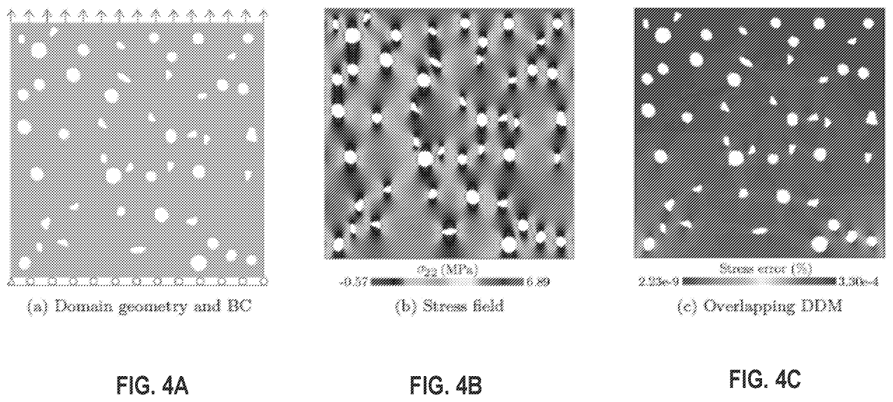

FIGS. 4A-4C illustrate the approximation of the field in a porous domain using both the non-overlapping and overlapping DDM techniques, together with the overlapping FE-DDM approximation of the stress field using 3×3 subdomains with 50% overlap and the corresponding error vs an FE simulation conducted on the entire field (direct numerical simulation). Specifically, FIG. 4A shows domain geometry and applied boundary condition, FIG. 4B shows overlapping FE-DDM approximation of the normal stress field in the y-direction, and FIG. 4C shows the corresponding error vs a direct numerical simulation using 9 subdomains with 50% overlap.

When using FEM for approximating the field in each subdomain, one important feature of the overlapping DDM that distinguishes that from the non-overlapping DDM is the ability to converge to a solution regardless of the quality and refinement level of the mesh. When using a coarse mesh, it is evident that the resulting solution would not be accurate. However, as noted previously, a non-overlapping DDM simulation would be highly sensitive to the mesh quality and the refinement level, as regardless of the value of 3, inaccurate tractions recovered in coarse elements or elements with a poor quality (high aspect ratio) could prohibit convergence.

At first glance, using 50% overlap between neighboring subdomains for the DDM simulation illustrated in FIGS. 4A-4C might seem to be an inappropriate choice, as using only 5% to 10% overlap between subdomains is a more common choice that also guarantees convergence. Further, for the same number of subdomains, a higher overlap percentage means larger subdomains and therefore more nodes/elements for discretizing them to keep the mesh refinement level intact. In the case of FE-DDM, since a 2D FE approximation computational cost is

$$O ( {N}_{D O F}^{2} ) ,$$

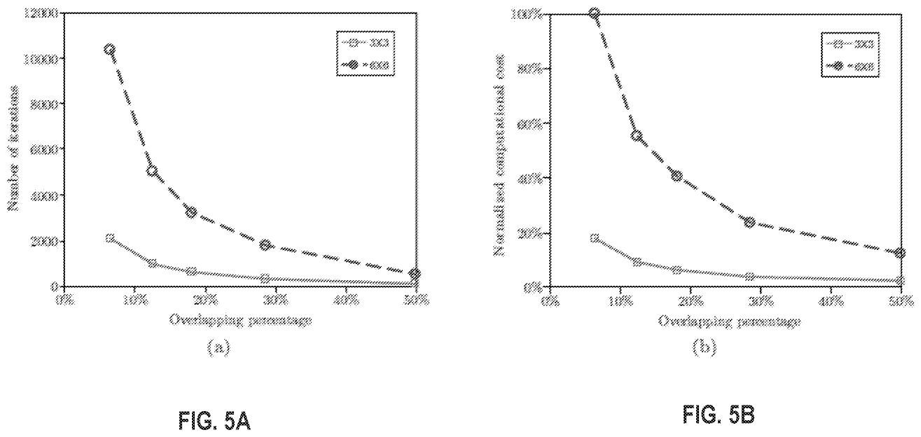

with N_{DOF} being the total number of degrees of freedom, this means the simulation time for approximating the field in each subdomain would be substantially higher. However, according to the study presented in [49] and summarized in FIGS. 5A-5B, a high overlap of 50% not only significantly expedites the overlapping DDM convergence but also reduces the total computational cost. As shown, using a higher overlap percentage significantly reduces the number of iterations needed for the overlapping DDM convergence. This significant reduction is more than enough to offset the increased time associated with approximating the field in each subdomain, resulting in a notable drop in the overall simulation time.

### DLD³ Algorithm

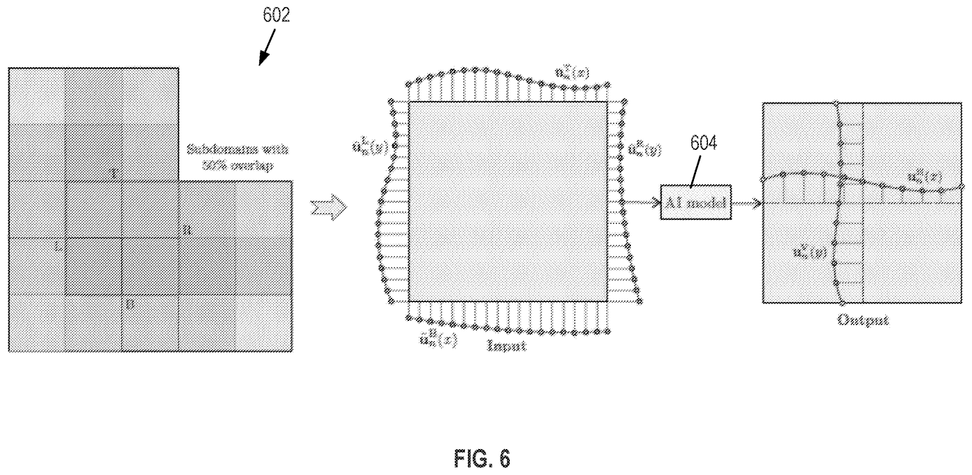

The main idea behind the DLD³ algorithm is to replace the FEM with an appropriate AI-based model in the overlapping DDM to approximate the field in subdomains with, in some implementations, a 50% overlap, as schematically shown in FIG. 6 for a simple domain with no curved edges. This disclosure contemplates that other percentages of overlap can be applied to various domain dimensions, for example, between 20% and 60% overlap. The study presented below on the impact of subdomain overlap percentage on the number of DDM iterations has been pivotal in selecting a 50% overlap between neighboring subdomains in the DLD³ method. Note that, regardless of the subdomain size, the computational cost of predicting the field in a subdomain using a trained AI model is constant and much smaller than a corresponding FE simulation. FIGS. 5A-5B are graphs illustrating the effect of the number of subdomains and the overlap percentage between neighboring subdomains in the overlapping DDM on the number of iterations (FIG. 5A) and the overall computational costs (FIG. 5B).

Therefore, the total cost of a DLD³ is proportional to the number of DDM iterations, which as shown in FIGS. 5A-5B, could considerably be reduced using subdomains with 50% overlap. While we could change this percentage depending on the domain dimensions, keeping that at 50% for all subdomains also facilitates the DLD³ implementation, as the trained AI model only needs to predict the displacements along horizontal and vertical midlines of subdomains at each iteration.

FIG. 6 illustrates using subdomains with 50% overlap 602 to discretize a domain in the DLD³ method to implement the overlapping Schwarz method to approximate the field. To update neighboring subdomain BCs during the DDM iterations, an AI model 604 is trained to predict the displacement field along the horizontal and vertical midlines of each subdomain

$$( {\overline{u}}_{n}^{H} , {\overline{u}}_{n}^{V} )$$

based on the Dirichlet BCs applied on the edges of this subdomain, i.e.,

$${\overline{u}}_{n}^{L} , {\overline{u}}_{n}^{B} , {\overline{u}}_{n}^{R} , {\overline{u}}_{n}^{T} .$$

As shown in FIG. 6, this characteristic highly facilitates subdividing a domain into overlapping subdomains, we first discretize the domain using a structured mesh and then merge all neighboring grids sharing a node to construct a subdomain.

One challenge toward the successful implementation of the DLD³ method is to construct the training dataset, and then select an appropriate AI model and train the AI model to accurately predict the field in each subdomain. For the simple case of a domain with no curved edges, as shown in FIG. 6, this training dataset consists of the BCs applied along square-shaped subdomain edges

$$( {\overline{u}}_{n}^{L} , {\overline{u}}_{n}^{B} , {\overline{u}}_{n}^{R} , {\overline{u}}_{n}^{T} )$$

and the corresponding displacement field within the domain (or simply the displacement along its horizontal and vertical midlines, i.e.,

$${\overline{u}}_{n}^{H} , {\overline{u}}_{n}^{V} ) .$$

While constructing such a dataset is a time-consuming process is a time-consuming process, it is a rather straightforward task that requires applying various BCs to a square-shaped domain discretized using a structured mesh and using FEM to approximate the field. The subsequent effort to train an AI model based on this dataset showed that even a simple ANN with two fully connected layers can be trained to accurately predict the field in the subdomain, although such a model is data-intensive and requires a dataset with >2 million entries to achieve a desirable level of accuracy, i.e., <1% vs a FEM simulation on a fine mesh. A better choice, however, is to implement the FNO as the pre-trained AI model in the DLD³ algorithm. This model is much more data efficient and although it is more computationally expensive to train due to its complexity, can achieve the same level of accuracy using only 500 thousand instances of training data.

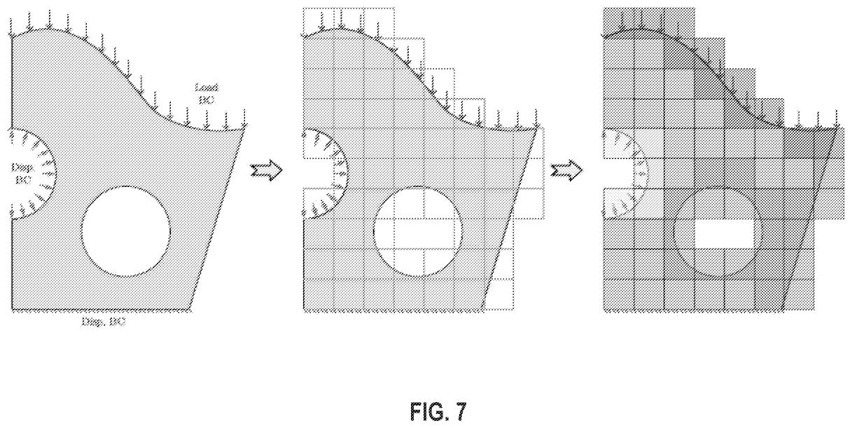

FIG. 7 illustrates partitioning a domain with arbitrary geometry and BCs for the DLD³ implementation. Various colors in the image on the right correspond to different types of subdomains depending on their geometry (with vs. without curved edges) and BCs (purely Dirichlet, Dirichlet-Neumann, etc.), where different DL models are used to predict their midline displacements during the DLD³ simulation.

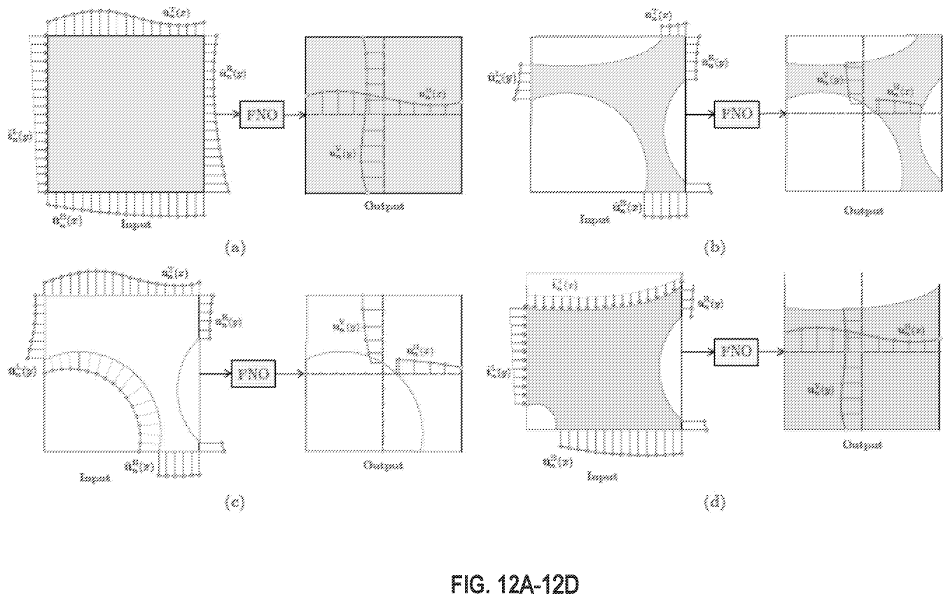

Constructing the training dataset and training either an ANN or an FNO model to predict the field in a square-shaped subdomain with no curved edge does not require advanced modeling capabilities, compute resources, or a highly optimized network architecture to achieve an acceptable level of accuracy. However, the situation is very different when trying to set up the pre-trained AI models in the DLD³ algorithm for modeling domains with more complex geometries and BCs, as shown in FIG. 7. In this case, some of the subdomains could have curved edges and, in some cases, either Dirichlet or Neumann BCs might be applied along these curved edges (in this work, we only study single-material domains). In FIG. 7, we have only shown the non-overlapping subdomains for better visuals, and subdomains are marked with different colors indicating their classification into different types depending on the geometric feature (with or without a curved edge) and BC type (Purely Dirichlet or Dirichlet-Neumann BCs, applied along straight or curved edges). The orange subdomains shown in FIG. 7 are the same type previously shown in FIG. 6, while the cases shown in other colors represent other types of subdomains requiring the training of new AI models to predict the field during the DDM iterations, as schematically shown in FIGS. 12A-12D. Note that, the choice to classify the subdomains into different types depending on their geometry/BC is made to avoid overloading a single network to predict the field in all subdomains, allowing the training of multiple AI models on a smaller dataset for each case to achieve better accuracy. The procedure used for constructing an appropriate training dataset consisting of millions of diverse entries for training the FNO models used in the DLD³ framework is described herein.

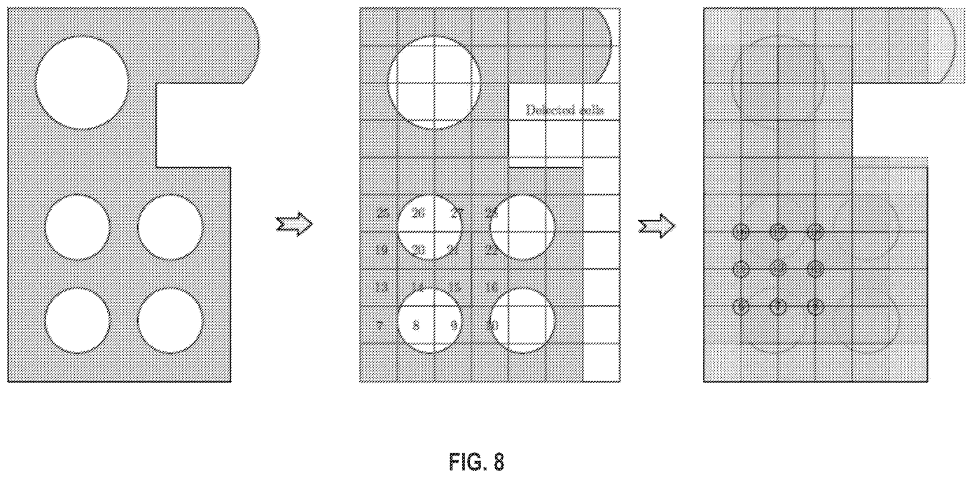

Before delving into the construction of the training dataset and designing/training the FNO models used in DLD³, it is worthwhile to describe the algorithm used for subdividing an arbitrary-shaped domain into 50% overlapping subdomains in this method. In this rather straightforward algorithm, the domain is first overlaid with a structured grid, as schematically shown in FIG. 8. Specifically, FIG. 8 illustrates subdividing a domain into overlapping subdomains by merging the cells of a structured grid and leveraging its nodal connectivity to build the connectivity table between resulting subdomains. Note that, the grid cells do not need to conform to the curved or straight edges of the domain, meaning the process is even easier than generating a structured mesh in this case. Before constructing the subdomains, any grid cell falling completely outside the domain boundaries is deleted. We then merge every 4 neighboring cells of the remaining portion of the grid to form a subdomain, which automatically guarantees all subdomains have 50% overlap with one another. For example, see subdomain \textcircled{12} in FIG. 8 which is formed by merging grid cells 14, 15, 20, and 21. The main motivation behind initially using a structured grid to construct the overlapping subdomains is to leverage the nodal connectivity of this grid to subsequently build a connectivity table for the resulting subdomains. Recall that such a connectivity table consists of identifying the overlapping subdomains and their relative location, i.e., BL, B, BR, RB, R, RT, etc., which is essential for updating BCs during the DDM iterations according to Equation (5). Referring back to FIG. 8, we can easily identify neighboring subdomains overlapping with \textcircled{12} and their relative locations based on the location of cells in each subdomain. For example, the bottom left quadrant of \textcircled{12} is grid cell 14, which is the right quadrant of subdomain \textcircled{6}; thus, the latter is identified as the subdomain overlapping with the bottom left quadrant of \textcircled{12}.

### Constructing Training Dataset

The FNO models used in the DLD³ algorithm receive a subdomain geometry, its elastic moduli, and the applied BC as the input and predict the displacement field in this subdomain. Training such a model requires access to a diverse dataset with millions of entries encompassing various subdominant geometries (void volume fraction, different edge curvatures, etc.) and boundary conditions (Dirichlet vs Neumann). As noted previously, we opt out to break down this massive data set into several subsets, classified based on subdomains with no curved edge vs solid, square-shaped subdomains. For the former, we further break the training dataset into subsets categorized based on the BC type (purely Dirichlet or involving Neumann BC along some edges), as well as whether the BC is only applied along straight edges or curved edges. This classification not only allows for training multiple FNO models on smaller datasets (reduces the training cost and facilitates learning) but also enables transfer learning from one model to the other (e.g., from the case with BC applied along straight edges to curved edges), reducing the total volume of data needed for training all models.

The training dataset used for training the FNO models in this work is obtained from high-fidelity FE simulations conducted on fine conforming meshes. The key challenge is to ensure the diversity of entries in this dataset, encompassing various geometries and BCs for training the FNO models. Moreover, given the large size of the dataset (several million entries) needed to properly train the FNO models, constructing this dataset would not be feasible without the complete automation of the FE modeling process, i.e., reconstructing the geometrical models, constructing the conforming meshes, performing the FE simulation, and extracting the final labeled data (input: subdomain geometry+BC, output: displacement field). To achieve this objective (automation) while assuring the construction of a diverse training dataset, we implement an integrated modeling framework relying on a virtual microstructure reconstruction algorithm [46, 50] and a parallel FE meshing algorithm [51, 48, 52, 53], originally developed for the modeling and computational design of composite materials with complex microstructures [54, 55, 56, 57] and later extended to other types of materials [58, 59].

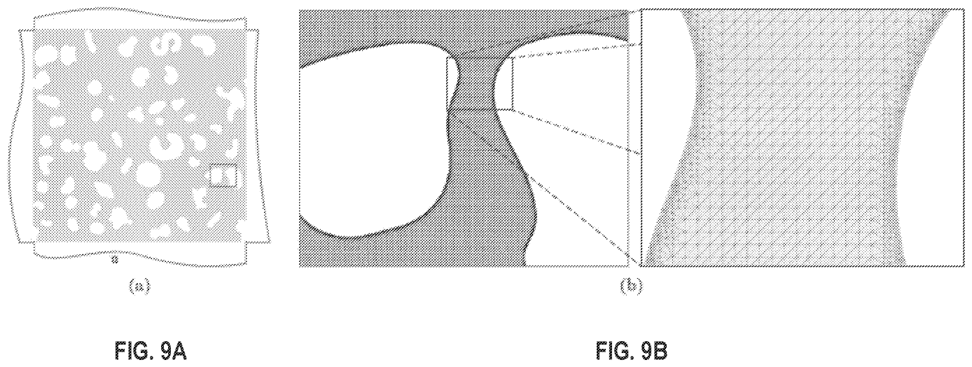

FIG. 9A shows an example of a virtually reconstructed geometrical model with embedded voids of various shapes, together with the Dirichlet BCs applied along the domain edges for the FE analysis. FIG. 9B depicts a small portion of the conforming mesh generated using CISAMR, corresponding to the inbox shown in FIG. 9A.

The construction of the training dataset begins with building a shape library of more than 100 inclusions, representing voids with various shapes and sizes, involving different curvatures (concave vs convex). The morphology of voids in this shape library is represented using Non-Uniform Rational B-Splines (NURBS) [60], which facilitate the subsequent mesh generation when these voids are used to build a geometrical model for FE simulation. The virtual packing algorithm introduced in [46] is then utilized to reconstruct a geometrical model by virtually embedding tens of these inclusions in a square-shaped domain, as in FIG. 9A of dimensions 100 m×100 m. Using a set of hierarchical bounding boxes (BBoxes) to represent an arbitrary-shaped inclusion, this algorithm utilizes these BBoxes to avoid overlap between embedded inclusions during the packing process. To extract the data needed for training the FNO models, we reconstructed approximately 1000 such models consisting of random-shaped inclusions, where the volume fraction of the embedded voids ranged between 15% to 30%.

After the reconstruction of thousands of geometrical models, FE approximation of the linear elastic response of each model requires employing a reliable algorithm to automatically generate a high-fidelity conforming mesh. Note that the accuracy of the FNO models used in DLD³ is highly dependent on the fidelity of the data used for their training, i.e., the accuracy of the approximated displacement fields, which in turn depends on the mesh quality (refinement level and element aspect ratios). To generate such meshes for 1000 virtually reconstructed porous domains, we implement the Conforming to Interface Structured Adaptive Mesh Refinement (CISAMR) algorithm introduced in [51, 48]. The CISAMR technique implements a set of non-iterative operations involving h-adaptivity, r-adaptivity, element deletion, and element subdivision to transform a structured grid into a conforming mesh with low element aspect ratios. For 2D problems, the algorithm ensures the element aspect ratios do not exceed 3, ensuring the construction of a high-quality mesh. After a meticulous mesh convergence study focused on comparing strain/stress values along void surfaces (local values coverage much slower than global norms of the error), each of the geometrical models being analyzed was discretized using a 1200×1200 background mesh composed of 4-node quadrilateral elements with two levels of h-adaptive refinement along void surfaces. Depending on the volume fraction of voids, the number of elements (consisting of 4-node quadrilaterals and 3-node triangles) in the resulting meshes is within the range of 3 to 3.5 million. FIG. 9B illustrates a small portion of the fine-conforming mesh generated using CISAMR for the porous domain shown in FIG. 9A.

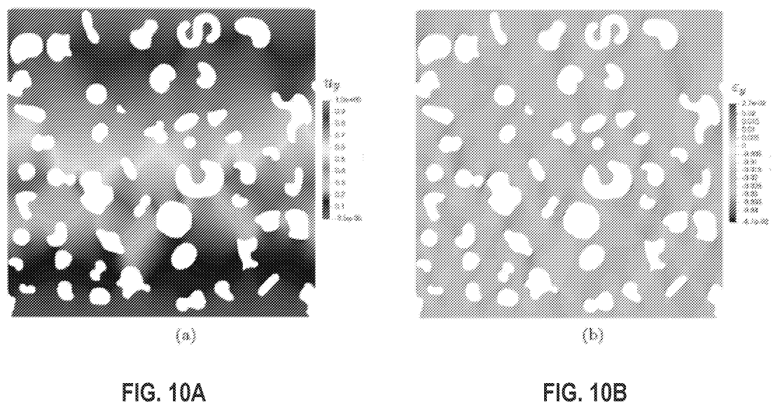

The conforming mesh generated for each geometrical model is then utilized to simulate its linear elastic FE response subjected to 15 different BCs. As schematically shown in FIG. 9A, the BCs (Dirichlet or Neumann) are considered to be a fifth-order polynomial with arbitrary coefficients. Also, for each simulation, we assign an elastic modulus of E=1 GPa and a random Poisson's ratio v between 0 and 0.5 to the solid material (the resulting field can be scaled up or down for other E values). In this work, all simulations and the corresponding training data correspond to plane stress problems. FIGS. 10A-10B illustrate the FE approximations of the displacement and strain fields in the domain shown in FIG. 9A assuming E=1 GPa and v=0.3. Specifically, FIG. 10A shows the approximation of displacement and FIG. 10B shows the approximation of strain fields in the y-direction for the domain and the corresponding CISAMR mesh shown in FIGS. 9A-9B.

After performing nearly 15000 FE simulations (1000 geometrical models, each subjected to 15 different BCs), 2000 subdomains and the corresponding BCs and displacement fields are extracted from each domain to collect a total of 30M labeled data. Note that, the 2000 subdomains were chosen in a manner that ensures an equal distribution of subdomains with single void (i.e., subdomains intersecting only with a single void), multiple voids (i.e., subdomains intersecting with at most three voids), and no voids (i.e., subdomains completely inside the solid region).

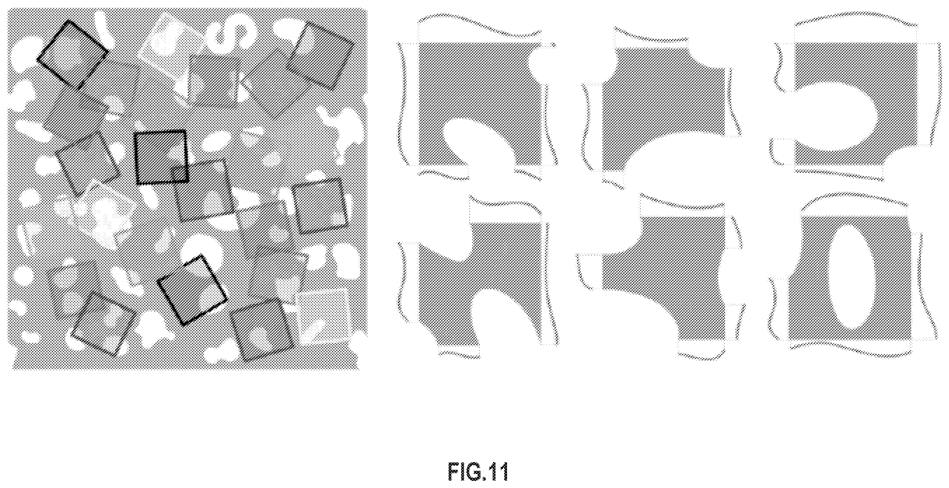

FIG. 11 illustrates extracting random subdomain geometries and the corresponding field/BC as entries into the training dataset. As shown in FIG. 11, the subdomains are selected by cropping a small square sub-region of the domain at a random location and orientation. Note that the subdomains could have different sizes due to the linear elastic nature of the problem being analyzed, as the resulting field/BC is scalable within the subdomain. However, as shown in FIG. 11, the subdomain sizes are selected within a range that intersects with at most three voids. Expanding the subdomain size beyond this range requires a higher-resolution (pixelated) representation of the geometry and field, resulting in a highly complex problem that requires many more million data entries for training the FNO models to achieve acceptable accuracy.

For each subdomain, the material properties (E and v) and the approximated displacement values (ux and uy) are extracted at the points of a 83×83 grid (total of 6889 points) to be used as a training data entry. To evaluate the displacement vector at each grid point, we must first identify which element among >3 million mesh elements holds this point, determine its local coordinate p in that element, and then interpolate the field at this point. Considering the massive volume of training data that must be extracted (>30 million), it is of utmost importance to optimize the efficacy and robustness of the algorithms used in this process to minimize the computational burden. The main computational cost during this process is associated with locating the element encompassing the point at which we aim to evaluate the field, which can significantly be expedited using a quad-tree search algorithm. In this approach, after sorting the mesh elements in a quad-tree data structure, we can quickly identify a handful of elements (<10) that potentially hold the given point. For a point with global coordinate xₚ, we then utilize the inverse of the isoparametric mapping xₚ=ΣNᵢ(ξₚ)xᵢ to determine the local coordinate ξₚ of the point in all elements identified through the quad-tree search (Nᵢ: shape function, xᵢ: global nodal coordinates). After calculating ξₚ, the point at which we aim to interpolate the field falls within a triangular element if 0≤(ξₚ)1≤1 and 0≤(ξₚ)2≤1, i.e., if it is within the local coordinate range for this element. For a rectangular element, the interior points of the element have a local coordinate within the range of −1 and 1. The displacement vector corresponding to each of the 6889 points of a subdomain can easily be interpolated based on its local coordinate as uₚ=ΣNᵢ(ξₚ)uᵢ, where uᵢ are nodal displacement vectors.

Note that although the dataset collected using the FE-based procedure above has nearly 30 million entries, only a small fraction of that (≈15%) is utilized for training the FNO models. This is due to the inhomogeneity of data, with a bias toward certain cases such as subdomains with a very low volume fraction of <5%. Even if that was not the case, training an FNO model on such a massive dataset (with each entry involving tens of thousands of parameters) would be an exceedingly computationally demanding task. This cost is characterized not only in terms of the training time but also the actual dollar cost, requiring multiple advanced GPUs and weeks of distributed training, which imposes a huge financial burden. Therefore, instead of attempting to use such a massive training dataset, we apply several filters to select some of the entries that form a smaller but more diverse dataset. These filters are based on the geometry, BC, and the approximated displacement field within each subdomain. The final data set consists of an equal number of subdomains intersecting with one, two, and three interfaces, as well as a uniform distribution of void volume fraction, V_{void}. For example, the volume number of subdomains with 0%<V_{vold}<5% and those with 95%<V_{vold}<100% is approximately the same in this dataset. We also filtered the entries based on the variation of the BC/field, as both cases with a small variation (small relative difference between max and min displacement values) and high variation must be included in the training data for different void volume fractions. Note that constructing the final training dataset has been one of the major challenges addressed in this study, which required several iterations (training the FNO models and then enriching the data to improve accuracy) to achieve an appropriate, diverse set of training data.

### Training FNO Models

FIGS. 12A-12D illustrate four different FNO models trained based on the subdomain geometry and applied BC. FIG. 12A shows a solid subdomain with Dirichlet and Neuman BC; FIG. 12B shows a porous subdomain with Dirichlet BC along its straight edges; FIG. 12C shows a porous subdomain with Dirichlet BC along its straight and curved edges; and FIG. 12D shows a porous subdomain with Dirichlet and Neumann BC.

As noted previously, multiple FNO models are utilized to predict the field in subdomains depending on their geometry (solid vs porous), BC type (Dirichlet vs Neumann), and applied BC location (straight vs curved edges). Besides the simple case of an FNO model predicting the field in a solid square subdomain (no curved edges) shown in FIG. 6, four other case scenarios for training different FNO models based on the shape/BC of the subdomain are illustrated in FIGS. 12A-12D. Note that the subdomains subjected to pure Dirichlet BCs along their straight edges (cf. FIG. 6 and FIG. 12B) are the most important cases, as all interior subdomains of a DLD³ model fall into this category. Moreover, after training an FNO model for either of these cases, transfer learning could be utilized to re-train the model on a smaller volume of data to predict the field in subdomains with BCs that are either of Neumann type or applied along curved edges. Therefore, in this section, we only discuss the architecture and training of the FNO model for predicting the field in porous subdomains with Dirichlet BC applied along their straight edges (FIG. 12B), as both the dataset structure and the training procedure are similar for other cases.

It is worth mentioning that there is no idiosyncratic feature in the FNO model necessitating its use in the DLD³ algorithm, meaning other network architectures such as CNN, U-Net, GAN, or PINN can also be utilized as the pre-trained AI models in this technique. However, we performed several numerical experiments using 150K to 200K training data comparing the accuracy of FNO with these other networks, all of which demonstrated a slightly to moderately better performance for the FNO model (10% to 50% less error). These observations were in line with the relative performance of the FNO model relative to various other networks in the literature, including those mentioned above [61, 44].

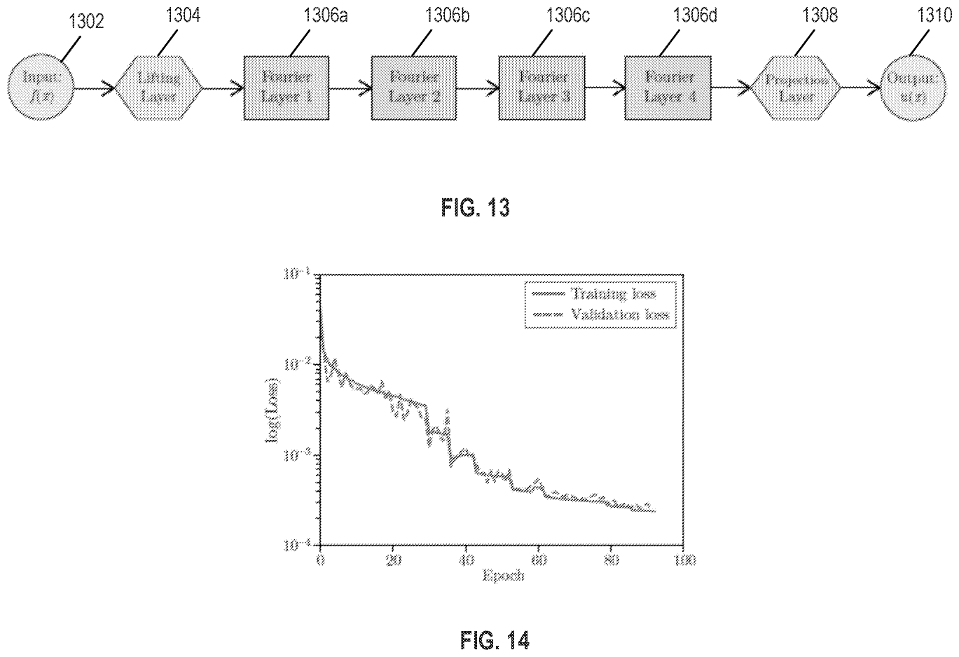

The architecture of the FNO model used in this work is illustrated in FIG. 13 which is a flowchart diagram illustrating a method for extracting random subdomain geometries and the corresponding field/BC as entries into the training dataset. As depicted in FIG. 13, the input data f(x) 1302 are first fed into a neural network lifting layer 1304, then fed into four Fourier layers (1306a, 1306b, 1306c, 1306d), and finally, another neural network (projection layer 1308) is deployed to map that into the output data u(x) 1310. The input f(x) 1302 consists of a concatenated array of 4×83×83, with each of the 83×83 arrays representing a spatial point with 4 given values: elastic modulus (in the void region, E=v=0), Poisson's ratio, and two BC values (e.g., baruₓ) and baru_{y} for Dirichlet BC). Note that the array containing the BC values has the corresponding BC values only at the boundary points and is padded in the interior with a chosen value of 3, which is outside the range of applied Dirichlet or Neumann BCs that is [−2, 2]. The output u(x) is the displacement vector at all points of this array. Note that, after the training, although the whole displacement field is predicted by the FNO model, only the midline horizontal and vertical displacement values are used during the DDM iterations in the DLD³ algorithm. Next, we provide a more detailed description of the FNO model, as well as the architecture used in this study.

The goal of an FNO model is to learn an infinite-dimensional space mapping from a finite set of input-output pairs. Let D⊂R^{d} be a bounded, open set; F and U be the input and output function spaces, which are separable Banach spaces of functions defined on D, that take values in R^{d}^{_{f}} and R^{d}^{ᵤ}, respectively. Also, let G: F→U be a nonlinear mapping that satisfies the governing partial differential equations (here, of linear elasticity), such that for input-output pairs

$${\{ fj , uj \}}_{j = 1}^{N} ,$$

where fⱼ∈F is sampled from a probability distribution μ defined on F and uⱼ∈U, we have uⱼ=G(fⱼ). Then, the neural operator constructs an operator G_{θ} that learns an approximation of G by minimizing the following problem using a cost function C as

$${min}_{θ ∈ Θ} {𝔼}_{f ∼ μ} [ C ( {G}_{θ} ( f ) , G ( f ) ) ] . \qquad ( 6 )$$

We use the n-point discretization Dⱼ=x₁, . . . , xₙ⊂D to numerically represent the functions f(x)ⱼ|Dⱼ∈R^{n×d}^{ᵤ}. In the present work, f(x)ⱼ refers to the input variables (E,v, and BC values), whereas u(x)ⱼ refers to the predicted displacement field. The architecture of an FNO model consists of three main components [13]:
1. The lifting layer L that transforms (lifts) the input f(x) into a higher dimensional space, v₀(x)=L(f(x)). As used in this work, a shallow fully connected neural network is often used as the lifting layer.
2. The Fourier layers, where T layers are used to iteratively update the lifted layer as Vₜ→Vₜ₊₁, where t=0, 1, . . . , T−1. Each update can be written as

$${v}_{t + 1} ( x ) := σ ( W {v}_{\text{?}} ( x ) + ( K ) f ; ϕ ) {v}_{\text{?}} ) ( x ) ) , ∀ x ∈ D , \qquad ( 7 )$$

$$\text{?} \text{indicates text missing or illegible when filed}$$

where W is a linear operator, a is the nonlinear activation function taken as the Gaussian error linear unit (GELU) activation, and K is the kernel integral operator defined as

$$( K ( f ; ϕ ) {v}_{\text{?}} ) ( x ) := {\int }_{d} κ ( x , y , f ( x ) , f ( y ) ; ϕ ) {v}_{\text{?}} ( y ) dy , ∀ x ∈ D . \qquad ( 8 )$$

$$\text{?} \text{indicates text missing or illegible when filed}$$

As described in [13], the kernel integral operator in (8) can be replaced by a convolution operator defined in the Fourier space as

$$( K ( f ; ϕ ) {v}_{\text{?}} ) ( x ) := {ℱ}^{- 1} ( {R}_{ϕ} \cdot ℱ ( {v}_{\text{?}} ) ) ( x ) , ∀ x ∈ D , \qquad ( 9 )$$

$$\text{?} \text{indicates text missing or illegible when filed}$$

where R_{φ}=F(K_{φ}) is the Fourier transform of a periodic function K, while F and F⁻¹F−1 refer to the Fourier transform and its inverse, respectively. Note that Rφ is parameterized using a truncated Fourier series expansion with a maximal number of frequency modes kₘₐₓ.
3. Finally, a shallow fully connected neural network is employed as the projection layer P to transform V_{T} back to the original space (here, the displacement field) as u(x)=P(V_{T}(x)).

In the present study, we trained two FNO models, one to predict uₓ and u_{y} independently, with each of the models using a fully connected neural network of one lifting layer with 4 input features (E, v, and BCs) and 64 output features, respectively. Each model has 4 Fourier layers with 64 input and 64 output features, where each layer uses kₘₐₓ=20 Fourier modes to learn the corresponding frequency information. Finally, we have a projection layer in both models comprised of yet another shallow fully connected neural network of 2 layers, with the first layer having 64 input features (to match the previous layers) and 128 output features. The second layer, which is the final output layer of the network has 128 input features, and 1 output feature (uₓ or u_{y}).

To train the FNO model above, we started with a batch size of 8 per GPU on 8× NVIDIA V100 (a global batch size of 64) and used the Mean Absolute Error (MAE) as the loss function. In our extensive numerical experiments, we observed that using a lower batch size gives lower validation MAE, and hence, during the training process, the global batch size is reduced by half every 30 epochs. The alternative to this adaptive approach option is to fully train the FNO model from scratch with a very low batch size, which could be exceedingly computationally demanding (months of training using these compute resources), as a higher batch size considerably reduces the training time. Furthermore, we adaptively decrease the learning rate to half of its value during the training process upon the plateauing of the validation loss with a tolerance of 5 epochs, i.e., if the validation loss does not improve in 5 consecutive epochs. An early stopping criterion is also utilized to stop the training if the validation loss does not further improve in 10 consecutive epochs.

After training the model on 700K data on 8×NVIDIA V100 for approximately two weeks, the variations of training and validation losses vs the number of epochs during this process are illustrated in FIG. 14 which is a graph depicting training and validation losses plotted against the number of epochs during the training of the FNO model. After 92 epochs, the training and validation losses were reduced to 2.4e-04 and 2.6e-04, respectively, where the latter is identical to the test loss (the test and validation datasets each have 150 k entries). The similarity of test, validation, and training losses of the trained FNO model indicates no overfitting and thereby proper generalizability to predict the field in subdomains with various geometries, BCs, and material properties when utilized in the DLD³ framework.

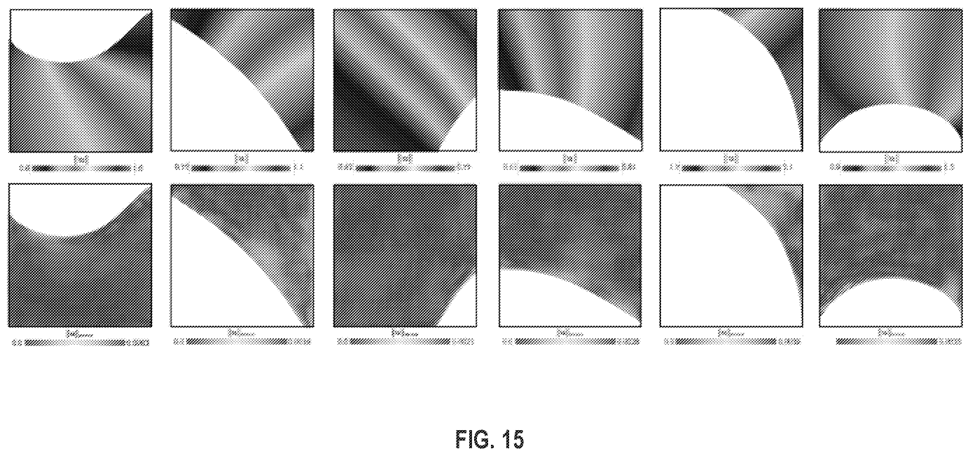

FIG. 15 shows the FNO prediction of the magnitude of the displacement field in several subdomains (first row) and the corresponding distribution of the error vs FE simulation of the field using conforming meshes (second row). FIG. 15 shows the prediction of the field in several subdomains with various geometries and BCs using the trained FNO model, together with the corresponding error vs FE simulation results conducted on conforming meshes, i.e., the ground truth used for training the model.

### NUMERICAL EXAMPLES

In this section, we demonstrate the application of the DLD³ algorithm for simulating the linear elastic response of plane stress problems with various geometries and boundary conditions. In some examples, we have also compared the accuracy of the DLD³ predictions with FE simulations conducted on conforming meshes. It is worth noting that the DLD³ simulations presented next are conducted on a GPU-CPU platform, where an NVIDIA V100 GPU is utilized to compute FNO predictions for each subdomain at a low cost of ~0.008 seconds for each model predicting uₓ and u_{y}. A 2.4 GHz Intel Xeon 6148 processor is then employed to update BCs during the DDM iterations, where the time taken to recover/update horizontal and vertical midline displacements for one porous sub-domain is approximately 0.017 seconds.

### Example 1: Simple Porous Domain

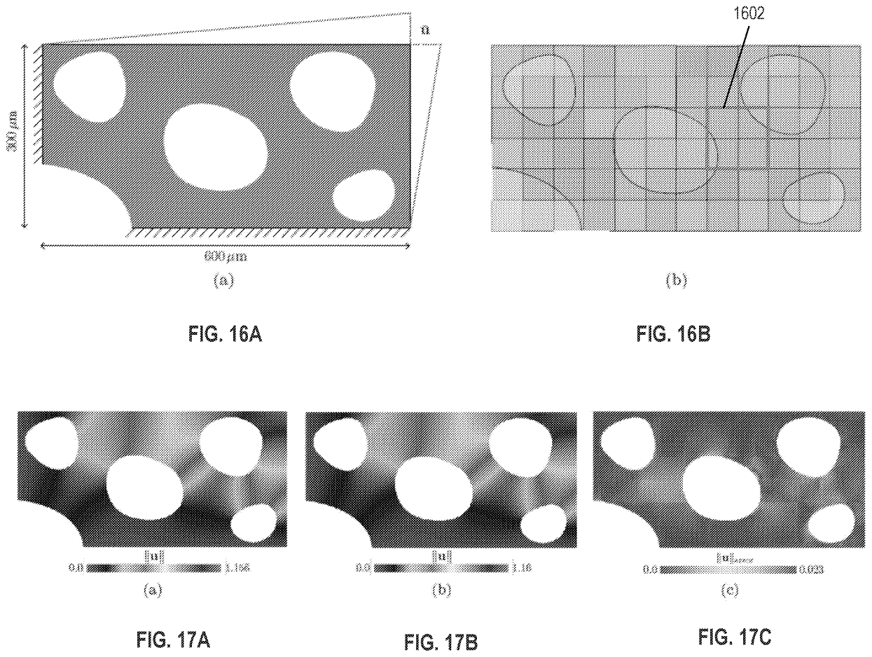

In this example, the DLD³ algorithm is implemented to approximate the displacement field in a 600 m×300 m porous domain, with the geometry and BC shown in FIGS. 16A-16B. FIG. 16A illustrates SVE geometry and applied BC. FIG. 16B illustrates 11×5 overlapping subdomains used for partitioning the domain to perform the DLD³ simulation, where one of the subdomains is highlighted in red (1602). Material properties of the solid part are assumed to be E=100 GPa and v=0.2. The domain has fixed BC along its bottom and ledge edges, while the following linear displacement BCs are applied along its top and right edges (The origin of the coordinate system in all examples is the bottom left corner of the domain):

$$Top edge : {\overline{u}}_{x} = 1.073 e - 3 x , {\overline{u}}_{y} = 1.608 e - 3 x , \qquad ( 10 )$$

$$Right edge : {\overline{u}}_{x} = 2.146 e - 3 y , {\overline{u}}_{y} = 3.215 e - 3 y , \qquad ( 11 )$$

FIGS. 17A-17C illustrate an example simple porous domain problem where FIG. 17A shows results from applying DLD³, FIG. 17B shows FE approximations of the displacement field magnitude, and FIG. 17C shows the relative error between DLD³ and FEM results. The DLD³ simulation is carried out by partitioning the domain into 11×5 overlapping subdomains (50% overlap), as shown in FIG. 16B. The DLD³ approximation of the displacement field magnitude and its comparison with an FE simulation carried out on a fine, conforming mesh is illustrated in FIG. 17A and FIG. 17B, respectively. In the DLD³ simulation, the field is initialized using a simple linear field corresponding to a domain with no porosity, resulting in 59 DDM iterations to achieve convergence. The distribution of error between the DLD³ and FEM approximations of the field, calculated as ∥u∥ₑᵣᵣₒᵣ=∥u∥_{DLD}_{³}−∥u∥_{FEM}| is illustrated in FIG. 17C. This example shows the proposed DLD³ yields a good accuracy for approximating the field in this problem after breaking down the original domain into smaller subdomains the response of which can accurately be predicted using the pre-trained FNO models.

### Example 2: L-Shaped Domain with Holes

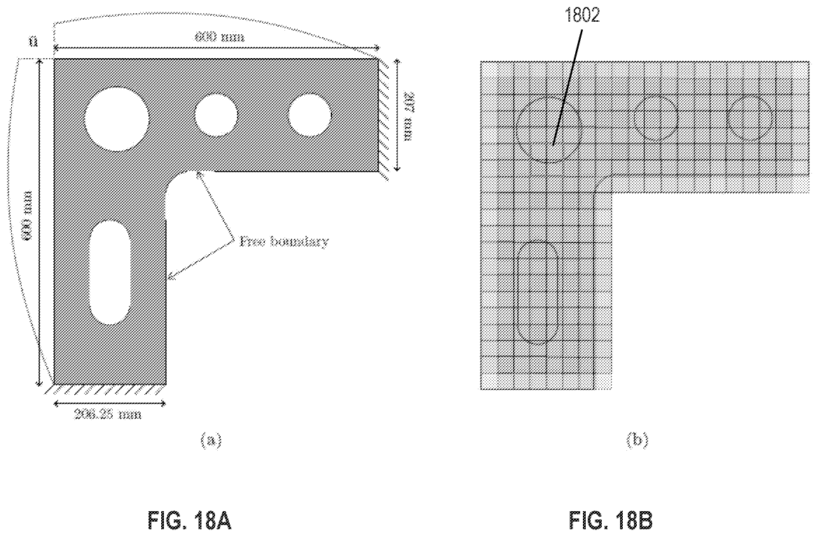

FIGS. 18A-18B illustrate a second example problem where FIG. 18A shows domain geometry and applied BC and FIG. 18B shows 217 overlapping subdomains extracted from a 19×19 partitioning of the domain to perform the DLD³ simulation, where one of the subdomains is highlighted in red (1802). In this example, the DLD³ algorithm is implemented to approximate the displacement field in an L-shaped domain with E=100 GPa and v=0.2, as shown in FIG. 18A. The bottom and right edges of the domain have fixed displacement BC, while the following quadratic displacement BCs are applied along the top and left edges:

$$Top edge : {{u}^{\text{?}}}_{x} = ( - 9.23 e - 06 ) {x}^{2} + ( 6.73 e - 03 ) x - 0.72 , \qquad ( 12 )$$

$${( {u}^{\text{?}} )}_{y} = ( - 9.1 e - 06 ) {x}^{2} + ( 4.71 e - 3 ) x + 0.45 ,$$

$$Left edge : {{u}^{\text{?}}}_{x} = ( 1.11 e - 05 ) {y}^{2} - ( 7.82 e - 3 ) y , \qquad ( 13 )$$

$${{u}^{\text{?}}}_{y} = ( 7.42 e - 06 ) {y}^{2} - ( 3.703 e - 3 ) y .$$

$$\text{?} \text{indicates text missing or illegible when filed}$$

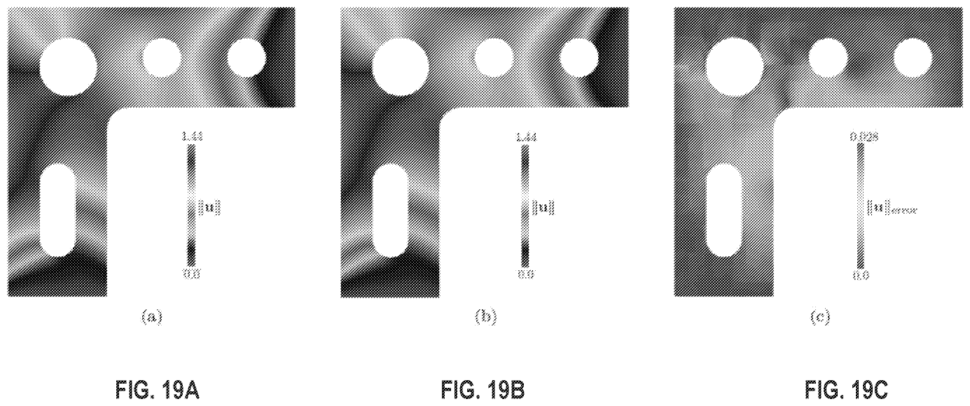

To perform the DLD³ simulation, the domain is originally partitioned using 19×19 overlapping subdomains. The subdomains falling outside the domain in the bottom right regions are then removed, meaning only 217 subdomains are used for approximating the field, as shown in FIG. 18B. Note that, as shown in FIG. 18B, the subdomains used for partitioning the domain do not need to conform to the domain boundaries. The resulting DLD³ approximation of the displacement field, its comparison with FE results, and their relative error are shown in FIGS. 19A-19C. Specifically, FIG. 19A shows results from applying DLD³, FIG. 19B shows FE approximations of the displacement field magnitude, and FIG. 19C shows relative error between DLD³ and FEM results. Once again, this example demonstrated the versatility of the AI-driven DLD³ framework to simulate problems with various geometries and BCs and the acceptable accuracy of the predicted field.

### Example 3: Porous Aluminum Microstructure

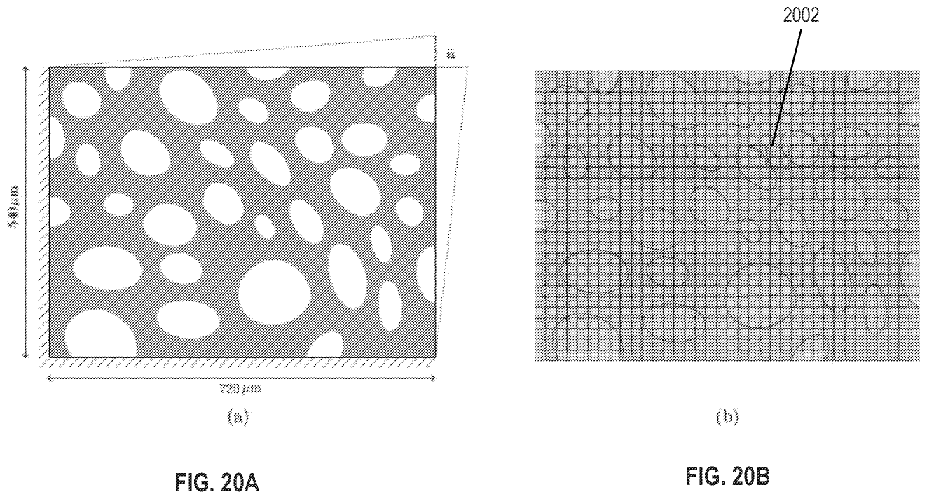

In this final example problem, we employ the DLD³ algorithm to approximate the displacement field in a statistical volume element (SVE) of a porous aluminum, with the geometry and BC shown in FIG. 20A. FIGS. 20A-20B illustrate a third example problem where FIG. 20A shows porous aluminum SVE geometry and applied BC and FIG. 20B shows overlapping subdomains used for partitioning the domain to perform the DLD³ simulation, where one of the subdomains is highlighted in red (2002). The elastic moduli of the aluminum phase are assumed to be E=70 GPa and v=0.2. Similar to the first example problem, the SVE was fixed displacement BC along its left and bottom edges, whereas the following linear displacement BCs were applied along its top and right edges:

$$Top edge : {\overline{u}}_{x} = 1.1414 e - 3 x , {\overline{u}}_{y} = 2.1448 e - 4 x , \qquad ( 14 )$$

$$Right edge : {\overline{u}}_{x} = 1.5218 e - 3 y , {\overline{u}}_{y} = 2.86 e - 4 y . \qquad ( 15 )$$

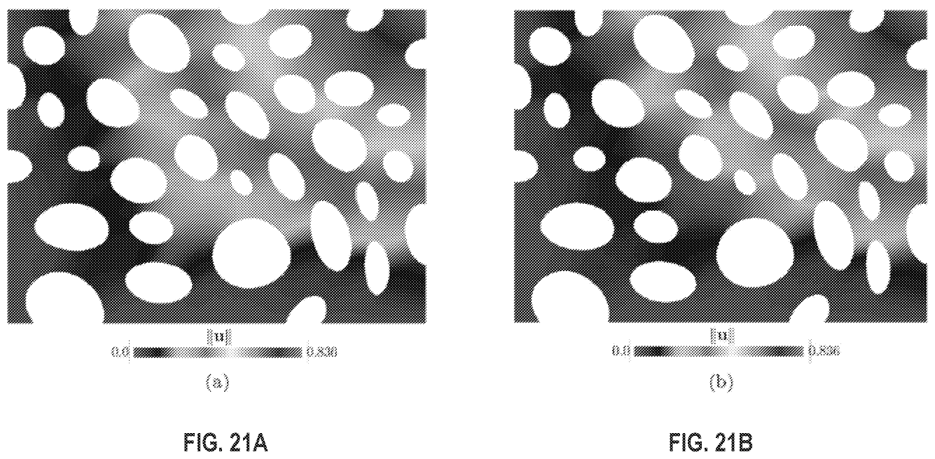

FIGS. 21A-21B show results from the third example problem. FIG. 21A shows results from applying DLD³ and FIG. 21B shows FE approximations of the displacement field magnitude. The DLD³ simulation was carried out on 910 overlapping subdomains (35×26 partitioning), as shown in FIG. 21A. The field was initialized using a linear displacement field corresponding to a domain with no porosity and the DDM solver converged after 705 iterations. The resulting DLD³ approximation of the field, together with its comparison with FE simulation results, are illustrated in FIG. 21B.

### CONCLUSION

Embodiments of the present disclosure provide a generalizable AI-driven framework coined Deep Learning-Driven Domain Decomposition (DLD³). DLD³ was introduced as a surrogate for FEM to approximate the linear elastic response of two-dimensional problems with arbitrary geometry and BC. This method relies on a set of pre-trained AI models (selected as the FNO model in this work) for predicting the displacement field (uₓ and u_{y}) in square-shaped subdomains of a larger domain, taking the geometry, BC, and material properties (E, v) as input. The pre-trained FNO models are then combined with the Schwarz overlapping domain decomposition method (DDM), enforcing 50% overlap between adjacent subdomains, to predict the field in the original domain by iteratively updating the subdomains BCs. Several example problems were presented to show the versatility of the DLD³ technique to accurately simulate the displacement field in single-material domains with various geometries and subject to different BCs. Our ongoing and future efforts entail extending the DLD³ method to multi-material and three-dimensional elasticity problems, as well as other constitutive models such as transient diffusion and plasticity. While the overall algorithm remains unchanged, a large dataset and substantial training power are required to ensure the pre-trained AI models used for predicting the field in subdomains of such problems are truly generalizable, regardless of the domain geometry and applied BC.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general-purpose or special-purpose computer or other machines with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machines with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with standard programming techniques with rule-based logic and other logic to accomplish the various connection steps, processing steps, comparison steps, and decision steps.

It is to be understood that the methods and systems are not limited to specific synthetic methods, specific components, or particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

The following patents, applications, and publications as listed below and throughout this document are hereby incorporated by reference in their entirety herein.
[1]T. M. Rodgers, J. E. Bishop, J. D. Madison, Direct numerical simulation of mechanical response in synthetic additively manufactured microstructures, Modelling and Simulation in Materials Science and Engineering 26 (2018) 055010.
[2]M. G. Geers, V. G. Kouznetsova, W. Brekelmans, Multi-scale computational homogenization: Trends and challenges, Journal of computational and applied mathematics 234 (2010) 2175-2182.
[3]S. Conti, P. Hauret, M. Ortiz, Concurrent multiscale computing of deformation microstructure by relaxation and local enrichment with application to single-crystal plasticity, Multiscale Modeling & Simulation 6 (2007) 135-157.
[4]F. Feyel, A multilevel finite element method (FE2) to describe the response of highly non-linear structures using generalized continua, Computer Methods in applied Mechanics and engineering 192 (2003) 3233-3244.
[5]R. Bostanabad, A. T. Bui, W. Xie, D. W. Apley, W. Chen, Stochastic microstructure characterization and reconstruction via supervised learning, Acta Materialia 103 (2016) 89-102.
[6]H. Xu, R. Liu, A. Choudhary, W. Chen, A machine learning-based design representation method for designing heterogeneous microstructures, Journal of Mechanical Design 137 (2015) 051403.
[7]R. Jha, N. Chakraborti, D. R. Diercks, A. P. Stebner, C. V. Ciobanu, Combined machine learning and calphad approach for discovering processing-structure relationships in soft magnetic alloys, Computational Materials Science 150 (2018) 202-211.
[8]Z. Yang, Y. C. Yabansu, R. Al-Bahrani, W.-k. Liao, A. N. Choudhary, S. R. Kalidindi, A. Agrawal, Deep learning approaches for mining structure-property linkages in high contrast composites from simulation datasets, Computational Materials Science 151 (2018) 278-287.
[9]Z. Yang, Y. C. Yabansu, D. Jha, W.-k. Liao, A. N. Choudhary, S. R. Kalidindi, A. Agrawal, Establishing structure-property localization linkages for elastic deformation of three-dimensional high contrast composites using deep learning approaches, Acta Materialia 166 (2019) 335-345.
[10]M. C. Messner, Convolutional neural network surrogate models for the mechanical properties of periodic structures, Journal of Mechanical Design 142 (2020) 024503.
[11]R. Liu, Y. C. Yabansu, A. Agrawal, S. R. Kalidindi, A. N. Choudhary, Machine learning approaches for elastic localization linkages in high-contrast composite materials, Integrating Materials and Manufacturing Innovation 4 (2015) 192-208.
[12]J.-L. Wu, H. Xiao, E. Paterson, Physics-informed machine learning approach for augmenting turbulence models: A comprehensive framework, Physical Review Fluids 3 (2018) 074602.
[13]Z. Li, N. Kovachki, K. Azizzadenesheli, B. Liu, K. Bhattacharya, A. Stuart, A. Anandkumar, Fourier neural operator for parametric partial differential equations, arXiv preprint arXiv:2010.08895 (2020).
[14]M. M. Rashid, T. Pittie, S. Chakraborty, N. A. Krishnan, Learning the stress-strain fields in digital composites using fourier neural operator, Iscience 25 (2022).
[15]E. Haghighat, M. Raissi, A. Moure, H. Gomez, R. Juanes, A deep learning framework for solution and discovery in solid mechanics, arXiv preprint arXiv:2003.02751 (2020).
[16]Z. Liu, C. Wu, M. Koishi, A deep material network for multiscale topology learning and accelerated nonlinear modeling of heterogeneous materials, Computer Methods in Applied Mechanics and Engineering 345 (2019) 1138-1168.
[17]M. Papadrakakis, N. D. Lagaros, Soft computing methodologies for structural optimization, Applied soft computing 3 (2003) 283-300.
[18]B. Le, J. Yvonnet, Q.-C. He, Computational homogenization of nonlinear elastic materials using neural networks, International Journal for Numerical Methods in Engineering 104 (2015) 1061-1084.
[19]L. Liang, M. Liu, C. Martin, W. Sun, A deep learning approach to estimate stress distribution: a fast and accurate surrogate of finite-element analysis, Journal of the Royal Society Interface 15 (2018).
[20]Z. Jun, Z. Youqiang, C. Wei, C. Fu, Research on prediction of contact stress of acetabular lining based on principal component analysis and support vector regression, Biotechnology & Biotechnological Equipment 35 (2021) 462-468.
[21]S. Dong, Z. Zhang, G. Wen, G. Wen, Design and application of unsupervised convolutional neural networks integrated with deep belief networks for mechanical fault diagnosis, in: 2017 Prognostics and system health management conference (PHM-Harbin), IEEE, 2017, pp. 1-7.
[22]F. Roewer-Despres, N. Khan, I. Stavness, Towards finite element simulation using deep learning, in: 15th international symposium on computer methods in biomechanics and biomedical engineering, 2018, p. 2018.
[23]D. Soukup, R. Huber-M\ddot{ }ork, Convolutional neural networks for steel surface defect detection from photometric stereo images, in: International symposium on visual computing, Springer, 2014, pp. 668-677.
[24]R. Kondo, S. Yamakawa, Y. Masuoka, S. Tajima, R. Asahi, Microstructure recognition using convolutional neural networks for prediction of ionic conductivity in ceramics, Acta Materialia 141 (2017) 29-38.
[25]S. P. Donegan, N. Kumar, M. A. Groeber, Associating local microstructure with predicted thermally induced stress hotspots using convolutional neural networks, Materials Characterization 158 (2019) 109960.
[26]M. Z. Alom, T. M. Taha, C. Yakopcic, S. Westberg, P. Sidike, M. S. Nasrin, M. Hasan, B. C. Van Essen, A. A. Awwal, V. K. Asari, A state-of-the-art survey on deep learning theory and architectures, electronics 8 (2019) 292.
[27]Z. Yang, X. Li, L. Catherine Brinson, A. N. Choudhary, W. Chen, A. Agrawal, Microstructural materials design via deep adversarial learning methodology, Journal of Mechanical Design 140 (2018) 111416.
[28]J. Langcaster, D. Balint, M. Wenman, Adapting U-Net for linear elastic stress estimation in polycrystal zr microstructures, Mechanics of Materials (2024) 104948.
[29]L. Ning, Z. Cai, Y. Liu, W. Wang, Conditional generative adversarial network driven approach for direct prediction of thermal stress based on two-phase material SEM images, Ceramics International 47 (2021) 34115-34126.
[30]H. Salehinejad, S. Sankar, J. Barfett, E. Colak, S. Valaee, Recent advances in recurrent neural networks, arXiv preprint arXiv:1801.01078 (2017).
[31]S. Freitag, W. Graf, M. Kaliske, J.-U. Sickert, Prediction of time-dependent structural behaviour with recurrent neural networks for fuzzy data, Computers & Structures 89 (2011) 1971-1981.
[32]F. Ghavamian, A. Simone, Accelerating multiscale finite element simulations of history-dependent materials using a recurrent neural network, Computer Methods in Applied Mechanics and Engineering 357 (2019) 112594.
[33]K. Sel, A. Mohammadi, R. I. Pettigrew, R. Jafari, Physics-informed neural networks for modeling physiological time series for cuffless blood pressure estimation, npj Digital Medicine 6 (2023) 110.
[34]G. S. Misyris, A. Venzke, S. Chatzivasileiadis, Physics-informed neural networks for power systems, in: 2020 IEEE power & energy society general meeting (PESGM), IEEE, 2020, pp. 1-5.
[35]W. Ji, W. Qiu, Z. Shi, S. Pan, S. Deng, Stiff-pinn: Physics-informed neural network for stiff chemical kinetics, The Journal of Physical Chemistry A 125 (2021) 8098-8106.
[36]R. Leiteritz, M. Hurler, D. Pfl\ddot{ }uger, Learning free-surface flow with physics-informed neural networks, in: 2021 20th IEEE International Conference on Machine Learning and Applications (ICMLA), IEEE, 2021, pp. 1668-1673.
[37]A. Henkes, H. Wessels, R. Mahnken, Physics informed neural networks for continuum micromechanics, Computer Methods in Applied Mechanics and Engineering 393 (2022) 114790.
[38]A. M. Roy, R. Bose, V. Sundararaghavan, R. Arr\acute{ }oyave, Deep learning-accelerated computational framework based on physics informed neural network for the solution of linear elasticity, Neural Networks 162 (2023) 472-489.
[39]Q. Zhu, Z. Liu, J. Yan, Machine learning for metal additive manufacturing: predicting temperature and melt pool fluid dynamics using physics-informed neural networks, Computational Mechanics 67 (2021) 619-635.
[40]H. You, Q. Zhang, C. J. Ross, C.-H. Lee, Y. Yu, Learning deep implicit fourier neural operators (IFNOs) with applications to heterogeneous material modeling, Computer Methods in Applied Mechanics and Engineering 398 (2022) 115296.
[41]N. Liu, S. Jafarzadeh, Y. Yu, Domain agnostic fourier neural operators, Advances in Neural Information Processing Systems 36 (2024).
[42]Z. Li, N. Kovachki, C. Choy, B. Li, J. Kossaifi, S. Otta, M. A. Nabian, M. Stadler, C. Hundt, K. Azizzadenesheli, et al., Geometry-informed neural operator for large-scale 3D PDEs, Advances in Neural Information Processing Systems 36 (2024).
[43]B. Raonic, R. Molinaro, T. De Ryck, T. Rohner, F. Bartolucci, R. Alaifari, S. Mishra, E. de Bezenac, Convolutional neural operators for robust and accurate learning of pdes, Advances in Neural Information Processing Systems 36 (2024).
[44]G. Wen, Z. Li, K. Azizzadenesheli, A. Anandkumar, S. M. Benson, U-FNO-an enhanced fourier neural operator-based deep-learning model for multiphase flow, Advances in Water Resources 163 (2022) 104180.
[45]M. Ji, M. Yang, S. Soghrati, A deep learning model to predict the failure response of steel pipes under pitting corrosion, Computational Mechanics 71 (2023) 295-310.
[46]M. Yang, A. Nagarajan, B. Liang, S. Soghrati, New algorithms for virtual reconstruction of heterogeneous microstructures, Computer Methods in Applied Mechanics and Engineering 338 (2018) 275-298.
[47]S. Soghrati, A. Nagarajan, B. Liang, Conforming to interface structured adaptive mesh refinement: new technique for the automated modeling of materials with complex microstructures, Finite Elements in Analysis and Design 125 (2017) 24-40.
[48]A. Nagarajan, S. Soghrati, Conforming to interface structured adaptive mesh refinement: 3D algorithm and implementation, Computational Mechanics 62 (2018) 1213-1238.
[49]M. Yang, S. Soghrati, On the performance of domain decomposition methods for modeling heterogenous materials, Computational Mechanics 69 (2022) 177-199.
[50]M. Yang, M. Ji, E. Taghipour, S. Soghrati, Cross-linked fiberglass packs: Microstructure reconstruction and finite element analysis of the micromechanical behavior, Computers and Structures 209 (2018) 182-196.
[51]S. Soghrati, A. Nagarajan, B. Liang, Conforming to Interface structured adaptive mesh refinement technique for modeling heterogeneous materials, Computational Mechanics 125 (2017) 24-40.
[52]B. Liang, A. Nagarajan, S. Soghrati, Scalable parallel implementation of cisamr: a non-iterative mesh generation algorithm, Computational Mechanics 64 (2019) 173-195.
[53]S. Pai, A. Nagarajan, M. Ji, S. Soghrati, New aspects of the cisamr algorithm for meshing domain geometries with sharp edges and corners, Computer Methods in Applied Mechanics and Engineering 413 (2023) 116111.
[54]B. Liang, A. Nagarajan, H. Ahmadian, S. Soghrati, Analyzing effects of surface roughness, voids, and particle-matrix interfacial bonding on the failure response of a heterogeneous adhesive, Computer Methods in Applied Mechanics and Engineering 346 (2019) 410-439.
[55]H. Ahmadian, B. Liang, S. Soghrati, Analyzing the impact of microstructural defects on the failure response of ceramic fiber reinforced aluminum composites, International Journal of Solids and Structures 97 (2016) 43-55.
[56]M. Ji, A. Smith, S. Soghrati, A micromechanical finite element model for predicting the fatigue life of heterogenous adhesives, Computational Mechanics (2022) 1-24.
[57]P. Zhang, S. Pai, J. S. Turicek, A. D. Snyder, J. F. Patrick, S. Soghrati, An integrated microstructure reconstruction and meshing framework for finite element modeling of woven fiber-composites, Computer Methods in Applied Mechanics and Engineering 422 (2024) 116797.
[58]B. Vemparala, W. H. Imseeh, S. Pai, A. Nagarajan, T. Truster, S. Soghrati, Automated reconstruction and conforming mesh generation for polycrystalline microstructures from imaging data, Applied Sciences 14 (2024) 407.
[59]R. P. Connor, B. Vemparala, R. Abedi, G. Huynh, S. Soghrati, C. T. Feldmeier, K. Lamb, Statistical homogenization of elastic and fracture properties of a sample selective laser melting material, Applied Sciences 13 (2023) 12408.
[60]P. L, T. W, The NURBS book, Springer Science & Business Media, 2012.
[61]S. Kapoor, J. Mianroodi, B. Svendsen, M. Khorrami, N. H. Siboni, Surrogate modeling of stress fields in periodic polycrystalline microstructures using U-Net and fourier neural operators, in: NeurIPS 2022 AI for Science: Progress and Promises, 2022.

1. A system for simulating a physical behavior of objects, the system comprising:
a processor; and
memory having instructions stored thereon that, when executed by the processor, cause the system to:
obtain a digital model of a physical object;
decompose the digital model into a plurality of subdomains, wherein the plurality of subdomains at least partially overlap;
independently solve each subdomain of the plurality of subdomains using a deep learning model, wherein the deep learning model is trained to predict horizontal and vertical displacements or a respective displacement field for each subdomain of the plurality of subdomains;
iteratively update boundary conditions for each of the plurality of subdomains based on the predicted horizontal and vertical displacements or the respective predicted displacement fields;
once convergence is achieved, predict at least one of a displacement field over the entire domain or a stress field using the updated boundary conditions for each subdomain of the plurality of subdomains; and
generate output data for the physical object based at least on the predicted displacement field over the entire domain and/or stress field, wherein the output data is employed in a computer-aided design system, simulation, or virtual reality system.

2. The system of claim 1, wherein the instructions further cause the system to:
train the deep learning model to predict a response of each of the plurality of subdomains using a training data set, wherein the training data set comprises at least one of subdomain geometry, material properties, horizontal and vertical displacements or the whole displacement field, and boundary conditions for a plurality of different types of subdomains.

3. The system of claim 2, wherein the training data set is generated using finite element domain decomposition method (FE-DDM) simulations or by extracting multiple subdomains from finite element simulation of the field in a larger domain to solve each of the plurality of different types of subdomains.

4. The system of claim 2, wherein the training data set is generated using finite element simulations to solve each of the plurality of different types of subdomains.

5. The system of claim 1, wherein the deep learning model is one of a plurality of deep learning models, wherein the instructions further cause the system to:
train the plurality of deep learning models, wherein each of the plurality of deep learning models is trained to predict a response of a unique type of subdomain.

6. The system of claim 5, wherein the plurality of deep learning models are trained using respective training data sets, wherein each of the training data sets comprises at least one of midline horizontal and vertical displacements or the whole displacement field, subdomain geometry, material properties, and boundary conditions for a respective unique type of subdomain.

7. The system of claim 5, wherein the plurality of deep learning models are trained using respective training data sets, wherein each of the training data sets comprises at least one of subdomain geometry, material properties, displacements along planes parallel to X-Y, X-Z, and Y-Z planes or the whole displacement field, subdomain geometry, material properties, and boundary conditions for a respective unique type of subdomain for a 3-dimensional (3D) physical object.

8. The system of claim 5, wherein the instructions further cause the system to:
identify one of the plurality of deep learning models that is applicable to each of the plurality of subdomains prior to independently solving each subdomain, wherein each of the identified deep learning models is used to solve a respective one of the plurality of subdomains.

9. The system of claim 1, wherein the stress field is predicted using a second deep learning model.

10. The system of claim 1, wherein the digital model is decomposed into the plurality of subdomains using an overlapping Schwarz method.

11. The system of claim 1, wherein the plurality of subdomains overlap by 50%.

12. The system of claim 1, wherein the plurality of subdomains overlap by between 10% and 80%.

13. The system of claim 1, wherein the deep learning model is a convolutional neural network or Fourier Neural Operator.

14. The system of claim 1, wherein the digital model of the physical object is a 2-dimensional (2D) or a 3-dimensional (3D) model representation of the physical object.

15. (canceled)

16. (canceled)

17. (canceled)

18. A method of simulating a physical behavior of an object, the method comprising:
obtaining a digital model of the object;
decomposing the digital model into a plurality of subdomains, wherein the plurality of subdomains at least partially overlap;
independently solving each subdomain of the plurality of subdomains using a deep learning model, wherein the deep learning model is trained to determine a respective displacement field or solution field for each subdomain of the plurality of subdomains;
iteratively update boundary conditions for each of the plurality of subdomains based on the respective predicted displacement fields or solution fields; and
once convergence is achieved, predict at least one of a displacement field or solution field over the entire domain or the stress field using the updated boundary conditions for each subdomain of the plurality of subdomains; and
generating output data for the physical object based at least on the predicted displacement field or solution field over the entire domain and/or stress field, wherein the output data is employed in a computer-aided design system, simulation, or virtual reality system.

19. The method of claim 18, further comprising:
training the deep learning model to predict a response of each of the plurality of subdomains using a training data set, wherein the training data set comprises at least one of subdomain geometry, material properties, horizontal and vertical displacements or the whole displacement field, and boundary conditions for a plurality of different types of
subdomains, wherein the training data set is generated using finite element domain decomposition method (FE-DDM) simulation or finite element simulations to solve each of the plurality of different types of subdomains.

20. (canceled)

21. (canceled)

22. The method of claim 18, wherein the deep learning model is one of a plurality of deep learning models, the method further comprising:
training the plurality of deep learning models, wherein each of the plurality of deep learning models is trained to predict a response of a unique type of subdomain.

23. (canceled)

24. The method of claim 22, wherein the plurality of deep learning models are trained using respective training data sets, wherein each of the training data sets comprises at least one of subdomain geometry, material properties, horizontal and vertical displacements or the whole displacement field, displacements along planes parallel to X-Y, X-Z, and Y-Z planes or the whole displacement field, and boundary conditions for a respective unique type of subdomain for a 3-dimensional (3D) object.

25. The method of claim 22, further comprising:
identifying one of the plurality of deep learning models that is applicable to each of the plurality of subdomains prior to independently solving each subdomain, wherein each of the identified deep learning models is used to solve a respective one of the plurality of subdomains.

26. (canceled)

27. (canceled)

28. (canceled)

29. (canceled)

30. (canceled)

31. (canceled)

32. (canceled)

33. (canceled)

34. (canceled)

35. A non-transitory computer-readable medium having instructions stored thereon that, when executed by a processor, cause a computing device to:
obtain a digital model of a physical object;
decompose the digital model into a plurality of subdomains, wherein the plurality of subdomains at least partially overlap;
independently solve each subdomain of the plurality of subdomains using a deep learning model, wherein the deep learning model is trained to predict horizontal and vertical displacements or a respective displacement field for each subdomain of the plurality of subdomains;
iteratively update boundary conditions for each of the plurality of subdomains based on the respective predicted horizontal and vertical displacements or the respective predicted displacement fields; and
once convergence is achieved, predict at least one of a displacement field over the entire domain or a stress field using the updated boundary conditions for each subdomain of the plurality of subdomains.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)
